(19) United States
(12) Patent Application Publication
(10) Pub. No.: US 2026/0349973 A1
(43) Pub. Date: Nov. 5, 2026

(54) System and Method for Validating a Mapping Rule for Messaging Standards

(71) Applicant: Mastercard International Incorporated, Purchase, NY (US)

(72) Inventor: Peter Groarke, Bublin (IE)

(21) Appl. No.: 19/196,564

(22) Filed: May 1, 2025

(51) Int. Cl. G06F 16/21

(52) U.S. Cl. CPC G06F 16/213

(57) ABSTRACT

Various implementations described herein may refer to a system and method for validating a mapping rule for messaging standards. In one implementation, a method may include receiving dictionary data associated with a first messaging standard, where the dictionary data defines data elements used by messages of the first messaging standard. The method may also include modifying the dictionary data based on the first messaging standard. The method may further include determining, based on the modified dictionary data, hierarchical paths corresponding to respective data elements. The method may include generating, based on the determined hierarchical paths, a path schema including a path data element that defines hierarchical locations for the data elements. The method may also include recording mapping rules data configured to translate between the first messaging standard and a second messaging standard, where recording the mapping rules data includes validating each mapping rule based on the path schema.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Parties associated with a business transaction may exchange electronic messages in accordance with one or more messaging standards. The business transaction may be any transaction relating to a business area and/or business process that is known in the art. For instance, the business transaction may be a payment transaction involving a payment card. Further, a party associated with the business transaction may include any entity capable of performing (e.g., conducting, facilitating, and/or processing) the business transaction. For example, for a payment transaction involving a payment card, the associated parties may include a cardholder, a merchant, an acquirer, a payment network, an issuer, and/or the like.

As is known in the art, the messaging standard for an electronic message may specify a structure, a format, and/or content of the message. Examples of the messaging standard may include the International Organization for Standardization (ISO) 20022 standard, the ISO 8353 standard, and/or the like. In some scenarios, multiple messaging standards may be employed by the associated parties when communicating electronic messages for a particular business transaction. In such scenarios, in order to perform the transaction, one or more of the associated parties may attempt to translate the electronic messages from one messaging standard to another messaging standard.

### SUMMARY

Described herein are implementations of various technologies relating to a system and method for validating a mapping rule for messaging standards. In one implementation, a method may include receiving dictionary data associated with a first messaging standard, where the dictionary data defines hierarchical relationships among a plurality of data elements used by one or more messages of the first messaging standard. The method may also include modifying the dictionary data based on the first messaging standard. The method may further include determining, based on the modified dictionary data, one or more hierarchical paths corresponding to respective data elements, where determining the one or more hierarchical paths comprises performing a traversal of the modified dictionary data. The method may additionally include generating, based on the determined hierarchical paths, a path schema including path data elements that define hierarchical locations and permissible values for the plurality of data elements. The method may also include recording mapping rules data configured to translate between the first messaging standard and a second messaging standard, where recording the mapping rules data includes validating each mapping rule based on the path schema.

In another implementation, a system may include one or more processors and at least one memory, where the at least one memory may include instructions executable by the one or more processors to cause the system to receive dictionary data defining hierarchical relationships among a plurality of data elements associated with messages of a first messaging standard. The instructions executable by the one or more processors to cause the system to also modify the dictionary data based on the first messaging standard. The instructions executable by the one or more processors to cause the system to further determine, through traversal of the modified dictionary data, one or more hierarchical paths associated with respective data elements. The instructions executable by the one or more processors to cause the system to additionally generate a path schema based on the hierarchical paths, the path schema constraining locations and permissible values for the data elements. The instructions executable by the one or more processors to cause the system to also record and validate mapping rules data configured for: translating between the first messaging standard and a second messaging standard; and comparing the mapping rules data against the path schema constraints.

In yet another implementation, a non-transitory computer-readable medium may store instructions that, when executed by a computer system, cause the computer system to receive dictionary data defining hierarchical relationships among a plurality of data elements associated with messages of a first messaging standard. The instructions may, when executed by a computer system, cause the computer system to also modify the dictionary data based on the first messaging standard. The instructions may, when executed by a computer system, cause the computer system to further determine, through traversal of the modified dictionary data, one or more hierarchical paths associated with respective data elements. The instructions may, when executed by a computer system, cause the computer system to additionally generate a path schema based on the hierarchical paths, the path schema constraining locations and permissible values for the data elements. The instructions may, when executed by a computer system, cause the computer system to also record and validate mapping rules data configured for: translating between the first messaging standard and a second messaging standard; and comparing the mapping rules data against the path schema constraints.

Implementations described herein provide techniques for validating mapping rules used to translate between messaging standards. These techniques leverage automated hierarchical traversal processes, such as XPath traversal, to uniquely identify data elements within complex messaging structures. Additionally, the techniques disclosed herein involve programmatically generating enumerated schemas to define permissible paths and data elements explicitly, enabling schema-compliant modeler tools to immediately detect and prevent errors during data mapping.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a four-party model in which one or more various technologies described herein may be incorporated and practiced.

FIG. 2 illustrates a schematic diagram of a system in accordance with implementations of various techniques described herein.

FIG. 3 illustrates a flow diagram of a method for validating a mapping rule for messaging standards in accordance with implementations of various techniques described herein

FIG. 4 illustrates a diagram of a computing device in which one or more various technologies described herein may be incorporated and practiced

### DETAILED DESCRIPTION

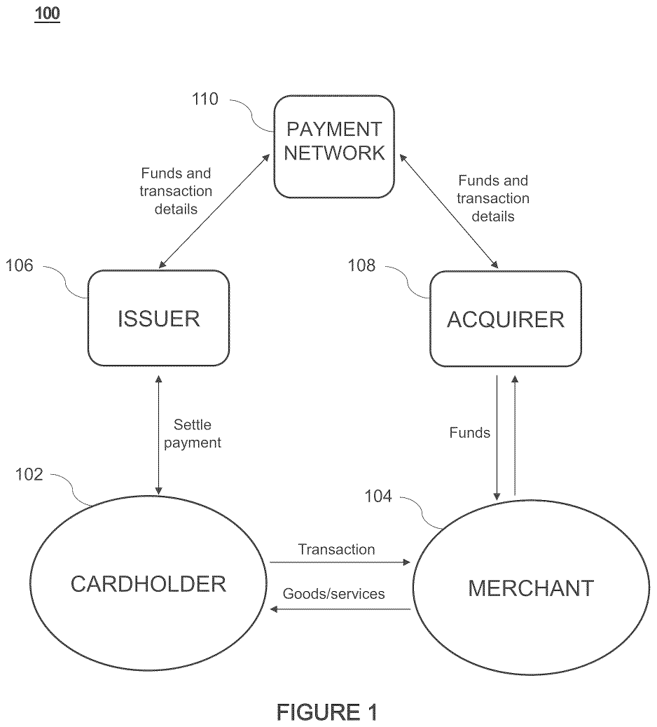

Various implementations directed to a system and method for validating a mapping rule for messaging standards will now be described in the following paragraphs with reference to FIGS. 1-4.

Inventive aspects disclosed herein address technical challenges associated with translating and validating messaging standards, particularly between complex formats such as ISO 20022 and ISO 8583. Existing approaches suffer from manual procedures, cumbersome mappings, high maintenance overhead, and frequent validation errors, exacerbated by evolving messaging standards and complex hierarchical structures. To overcome these challenges, the described innovations provide a structured, automated methodology leveraging dictionary data to dynamically record and validate user-defined mapping rules in a schema-compliant manner. Specifically, dictionary data is programmatically modified to reflect evolving messaging standards, hierarchical paths are automatically determined using traversal algorithms (e.g., XPath traversal), and path schemas are generated to explicitly constrain permissible data element structures and values, thereby enabling users to accurately define and record valid mappings between messaging standards.

In certain implementations, precise XPath traversal methodologies are employed to clearly manage class-based hierarchical structures, particularly where identical data classes appear in multiple locations, thus eliminating ambiguities inherent in manual mappings. Further, XPath traversal results are used to programmatically generate enumerated schemas that explicitly define allowable data values and paths. Correspondingly, schema-compliant modeler tools using these enumerated schemas provide immediate, real-time validation and error detection, further enhancing accuracy and reliability during message translation processes. Additionally, the invention introduces systematic recordation of mapping rules, validated rigorously through comparison against schema-defined constraints via the modeler tool. This automated validation substantially reduces manual intervention, minimizes mapping errors, and ensures strict compliance across diverse messaging standards.

Consequently, the described systems and methods provide substantial technical improvements, including enhanced accuracy in message translation, reduced maintenance burdens, improved processing efficiency, and greater interoperability across financial messaging platforms.

### I. Electronic Messages

Parties associated with a business transaction may exchange one or more electronic messages. A party associated with the business transaction may include any entity capable of performing (e.g., conducting, facilitating, and/or processing) the business transaction. In particular, the party may be any entity known in the art, including, but not limited to, the following: an individual person, a group of people, a family, a partnership, a corporation, a company, a commercial entity, a financial institution (e.g., a bank, a credit card company, etc.), a governmental entity, a non-profit organization, and/or the like. In addition, an electronic message may refer to a set of structured data exchanged between at least two parties associated with a business transaction.

### A. Business Transaction

The business transaction may be any transaction relating to any business area and/or business process known to those skilled in the art, where the transaction may be associated with parties that exchange electronic messages. For example, the business transaction may be a bank services transaction between a financial institution (e.g., a bank) and a customer (e.g., a bank account holder), a financial investigations transaction between a financial institution (e.g., a bank) and a government agency, a management transaction between an automated teller machine (ATM) and a financial institution (e.g., a bank), and/or the like.

Another example of a business transaction in which associated parties exchange electronic messages may be a payment transaction that involves a payment card, where such a payment transaction may follow a typical four-party model known to those skilled in the art. A payment transaction that involves a payment card may hereinafter be referred to a payment card transaction.

FIG. 1 illustrates a schematic diagram of a four-party model 100 in which one or more various technologies described herein may be incorporated and practiced. In particular, the four-party model 100 may correspond to a payment card transaction. As shown, for a payment card transaction, the four-party model 100 may include at least four associated parties: a cardholder 102, a merchant 104, an issuer 106, and an acquirer 108. In addition, such transactions often involve electronic messages exchanged between these entities, where such messages conform to different messaging standards (e.g., ISO 20022, ISO 8583, etc.). Converting between these standards is typically error-prone, manual, and cumbersome.

In certain implementations, inventive aspects disclosed herein significantly streamline the translation between these messaging standards. Automated hierarchical traversal processes (e.g., an XPath traversal process) are leveraged to accurately determine paths within complex message structures. Additionally, enumerated schemas generated from these traversals enforce strict schema compliance. Schema-compliant modeler tools further enhance the accuracy and reliability of mapping translations through immediate, real-time validation.

Moreover, a payment network 110 facilitates secure and efficient communication of transaction information among these entities, ensuring compliance and interoperability. With respect to FIG. 1, the payment card transaction may be a transaction in which the cardholder 102 attempts to purchase one or more products from the merchant 104 using a payment card. The cardholder 102 may be any type of party known in the art, including those described above (e.g., an individual). The payment card may be any type of card known in the art, including a physical card or a virtual card. Examples of the payment card may include, but are not limited to, the following: a debit card, a credit card, a prepaid card, a virtual payment card, virtual payment numbers, virtual card numbers, a foreign exchange card, a charge card, a stored-value card, and/or the like. As is known in the art, the payment card may be linked with a payment account associated with the cardholder 102, such that the cardholder 102 can use the payment card to fund a payment transaction via the payment account. The payment account may be any type of financial account known to those skilled in the art, including a banking account, a checking account, a savings account, a credit card account, a debit card account, a prepaid card account, a virtual payment account, and/or the like.

The merchant 104 may be any type of party known in the art, such as those described above (e.g., a company), where the party may be capable of providing the one or more products for sale to the cardholder 102. The one or more products may include any good and/or service known to those skilled in the art. Examples of the one or more products may include, but are not limited to, one or more of the following: parts, materials, merchandise, supplies, equipment, components, food, and/or the like.

Initially, to perform the payment card transaction, the cardholder 102 may provide the merchant 104 with data corresponding to the payment card, which may be in the form of an electronic message to the merchant 104. Data corresponding to the payment card may hereinafter be referred to as payment card data, where the payment card data may include data corresponding to a primary account number (PAN) for the payment card, an expiration date for the payment card, a Card Validation Code (CVC) for the payment card, and/or the like. As is known in the art, the cardholder 102 may provide the merchant 104 with the electronic message in a number of ways. In one example, the electronic message may be provided based on a swiping of a magnetic stripe of a physical payment card through a magnetic stripe reader of a merchant point-of-sale (POS) device. In another example, the electronic message may be provided based on communication between an integrated circuit (IC) of a physical payment card (i.e., a chip card, a smart card, and/or the like) and a smart card reader of the merchant POS device. Such a payment card may be configured to communicate with the smart card reader via contact-based and/or contactless communication. In yet another example, a computing device (e.g., a mobile device, a laptop computing device, a wearable device, and/or the like) may be configured to transmit the electronic message and/or the payment card data to a merchant system of the merchant, where the merchant system may include the merchant POS device, a merchant server, and/or the like. In a further example, the payment card data may be stored on the computing device (e.g., via a wallet application), such that the computing device may be used to act as a proxy of a physical payment card or as a virtual payment card.

The merchant 104 may then perform the payment card transaction by transmitting an electronic message among one or more other parties, such as the acquirer 108, the payment network 110, and the issuer 106. In particular, the merchant 104 may transmit the electronic message to the acquirer 108. As is known in the art, the acquirer 108 may be a party (e.g., a financial institution) that provides one or more services for the processing of payment card transactions for the merchant 104. The electronic message from the merchant 104 may include the payment card data, payment card transaction data, authorization request data, and/or the like. Payment card transaction data may include data corresponding to one or more details of the payment card transaction, where the one or more details may include a transaction amount of the payment card transaction, a time of the payment card transaction, an identifier of a particular computing system (e.g., the merchant POS device) used in the payment card transaction, a transaction identifier, and/or the like. Authorization request data may include data corresponding to a request for the issuer 106 to approve the payment card transaction, where the issuer 106 is associated with the payment card.

Based on the electronic message received from the merchant 104, the acquirer 108 may transmit an electronic message to the payment network 110, where the message may contain the payment card data, the payment card transaction data, the authorization request data, and/or the like. The payment network 110 may refer to a network and/or collection of systems used to facilitate payment card transactions for the acquirer 108 and the issuer 106. In particular, the payment network 110 may be a network and/or collection of systems configured to transfer funds through the use of cash and/or cash-substitutes via any protocols or procedures known in the art. Based on the electronic message received from the acquirer 108, the payment network 110 may transmit another electronic message to the issuer 106, where this message may similarly contain the payment card data, the payment card transaction data, the authorization request data, and/or the like.

As is known in the art, the issuer 106 may be a party (e.g., a financial institution, such as a bank, a credit card company, and/or the like) that maintains the payment account for the cardholder 102 and issues the payment card associated with the account to the cardholder 102. Based on the received electronic message, the issuer 106 may generate authorization response data. The authorization response data may include data indicating that the issuer 106 either approves or declines the payment card transaction. For a successful payment card transaction, the issuer 106 may, based on the electronic message received from the payment network 110, provide authorization response data indicating that the payment card transaction is approved. For an unsuccessful payment card transaction, the issuer 106 may, based on the received electronic message, provide authorization response data indicating that the payment card transaction is declined. In a further example, the cardholder 110 may be required to provide verification information (i.e., via an electronic message) pertaining to the transaction and, in some circumstances, may be required to undergo an additional verification process to verify their identity (e.g., via 3-D Secure for an online payment card transaction). Once the additional verification process has been completed, the issuer 106 may provide the authorization response data.

The authorization response data from the issuer 106 may be provided to the payment network 110 via an electronic message. In turn, the payment network 110 may transmit the authorization response data to the acquirer 108 via another electronic message. The acquirer 108 may then provide the authorization response data to the merchant 104 via yet another electronic message, thereby allowing the merchant 104 to complete its transaction with the cardholder 102.

Upon completion of the transaction between the cardholder 102 and the merchant 104, the merchant 104 may submit (i.e., via an electronic message) one or more details of the payment card transaction (e.g., the payment card transaction data) to the acquirer 108 for clearing and settlement. Clearing may refer to the process by which a merchant 104 and its acquirer 108 may submit (i.e., via an electronic message) the one or more details of the payment card transaction to the issuer 106. Settlement may refer to a final transfer of funds between parties (the issuer 106, the payment network 110, the acquirer 108, and/or the like), which may also involve an exchange of electronic messages among the parties. In particular, upon receipt of the payment card transaction data, the issuer 106 may provide the settlement funds to the payment network 110, which in turn may forward these funds to the merchant 104 via the acquirer 108.

In some instances, the payment network 110 may be operated by and/or provided by an entity, where the entity may be related to at least one other element of the four-party model 100. In one instance, the payment network 110 may be related to the issuer 106, such that the payment network 110 may perform one or more of the operations described herein for the issuer 106. In other instances, the payment network 110 may be operated by and/or provided by an entity that is separate from and/or unrelated to other elements of the four-party model 100. Examples of the payment network 110 may include those operated by Mastercard®.

Thus, for the payment card transaction of the above-described example, the four-party model may include multiple parties that perform the payment card transaction using an exchange of electronic messages, where the parties may include the cardholder 102, the merchant 104, the issuer 106, the acquirer 108, and the payment network 110. For other examples involving a payment card transaction, different arrangements may be possible. For instance, payment card transactions may be possible where the issuer 106 and the acquirer 108 are the same entity, in which case a routing of the transaction (e.g., an exchange of electronic messages) between the two parties may not be required. Additionally, it may be possible to have a four-party model that uses fewer electronic messages than as described above, such as where the authorization, clearing, and settlement may occur at the same time (e.g., via a single electronic message).

### B. Messaging Standard

In some scenarios, parties associated with a business transaction may exchange electronic messages in accordance with a messaging standard. As is known in the art, a messaging standard may specify, at least, a structure, a format, and/or content for one or more electronic messages associated with a business transaction. In such scenarios, the use of the messaging standard among the associated parties may assist with an interoperability between the parties, such as by facilitating a flow and/or processing of the electronic messages relating to the business transaction. In particular, by following the messaging standard, the associated parties may have a common understanding of the structure, the format, and/or the content of electronic messages exchanged amongst the parties. Such messages may include any electronic message known to those skilled in the art, including, but not limited to, the following: one or more financial messages, one or more payment card transaction messages, one or more securities messages, and/or the like.

The messaging standard may be any messaging standard known to those skilled in the art, including, but not limited to, the following: the International Organization for Standardization (ISO) 20022 standard, the ISO 8583 standard, the ISO 15022 standard, the Society for Worldwide Interbank Financial Telecommunication (SWIFT) MT standards, the Financial Information exchange (FIX) standard, and/or the like. In one example, the ISO 20022 standard may specify a structure, a format, and/or content for electronic messages associated with various business transactions, where these electronic messages may include, but are not limited to, the following: an “AuthorisationInitiationV02” message for use with a payment card transaction, a “BankServicesBillingStatementV05” message for use with a bank services transaction, a “InformationRequestOpeningV02” message for use with a financial investigations transaction, and so forth.

As is also known in the art, the messaging standard may utilize one or more message definitions in order to specify the structure, the format, and/or the content of its one or more electronic messages. Each message definition may be associated with a specific electronic message of the messaging standard (e.g., the “AuthorisationInitiationV02” message of the ISO 20022 standard), such that the message definition may correspond to a description of the structure, the format, and/or the content for that specific message. In particular, an associated party may utilize data relating to one or more message definitions in order to generate, process, and/or communicate one or more electronic messages in accordance with a messaging standard.

In one scenario, a message definition for a particular message may be composed of one or more data components, where each data component may be used to define a structure, a format, and/or content for specific data to be included in that message. In such a scenario, a data component may correspond to a class. As is known in the art, a class may be used to define a structure and/or behavior of an object (i.e., an instance) created from the class. In a further scenario, a data component of a message definition may correspond to an object created from a particular class.

The data relating to the one or more message definitions for the one or more electronic messages may hereinafter be referred to as message definition data. In addition, as is known in the art, the message definition data may be included in one or more schema documents, where such documents may be utilized by one or more of the associated parties. In particular, a schema document may be associated with one or more specific messages of the messaging standard, such that the schema document may include message definition data for those one or more specific messages. In one instance, a specific schema document may be associated with a single message of the messaging standard, such that the schema document may include message definition data for that single message. In another instance, a schema document may be associated with multiple messages of the messaging standard, such that the schema document may include message definition data for each of these multiple messages. A schema document that includes message definition data for one or more electronic messages may hereinafter be referred to as a message schema or a message schema document.

Thus, an associated party may utilize one or more message schemas in order to generate, process, and/or communicate one or more electronic messages in accordance with a messaging standard. The message definition data included in a particular message schema may be in a machine-readable format. In particular, the message definition data may be expressed using any syntax and/or file format known to those skilled in the art, including Extensible Markup Language (XML), JavaScript Object Notation (JSON), and/or the like. In one instance, as is known in the art, a message schema may be an XML Schema document, where the message definition data included in the message schema may be expressed using XML. For such an instance, the message schema may have “.xsd” as a filename extension.

For example, the ISO 20022 standard may be associated with message schemas for various electronic messages of the standard, such as a “cain.001.001.02” message schema for the “AuthorisationInitiationV02” message mentioned above. As is known in the art, the “AuthorisationInitiationV02” message may be utilized by a party (e.g., an acquirer) associated with a payment card transaction. The “cain.001.001.02” message schema may include message definition data for the “AuthorisationInitiationV02” message, where the message definition data may indicate that multiple data components are included in the message definition for the message. In addition, the message definition data for the “AuthorisationInitiationV02” message may be expressed using XML syntax. A portion of the “cain.001.001.02” message schema that includes this message definition data is shown below in Table 1.

```
TABLE 1
<?xml version=“1.0” encoding=“UTF-8”?>
<!--Generated by Standards Editor (build:R1.6.16) on 2020 May 26 08:54:36, ISO 20022 version :
2013-->
<xs:schema xmlns=“urn:iso:std:iso:20022:tech:xsd:cain.001.001.02”
xmlns:xs=“http://www.w3.org/2001/XMLSchema” elementFormDefault=“qualified”
targetNamespace=“urn:iso:std:iso:20022:tech:xsd:cain.001.001.02”>
. . .
  <xs:complexType name=“AuthorisationInitiationV02”>
    <xs:sequence>
      <xs:element name=“Hdr” type=“Header42”/>
      <xs:element name=“Body” type=“AuthorisationInitiation1”/>
      <xs:element maxOccurs=“1” minOccurs=“0” name=“SctyTrlr”
  type=“ContentInformationType20”/>
    </xs:sequence>
  </xs:complexType>
. . .
</xs:schema>
```

As shown in the message definition data of Table 1, the message definition for the “AuthorisationInitiationV02” message may correspond to a complex type element named “AuthorisationInitiationV02.” As is also shown, this complex type element may include a “Hdr” element of a type “Header42,” a “Body” element of a type “AuthorisationInitiation1,” and a “SctyTrlr” element of a type “ContentInformationType20.” In particular, the “Hdr,” “Body,” and “SctyTrlr” elements may be data components of the message definition for the message, such that the “AuthorisationInitiationV02” message may include data that corresponds to these data components. Further, as explained above, these data components may also correspond to classes. In addition, as shown in Table 1, the message definition (e.g., the “AuthorisationInitiationV02” element) for the message may also correspond to a class, such that the message (i.e., the “AuthorisationInitiationV02” message) created using this message definition may represent an object (i.e., an instance) created from a class.

### C. Data Dictionary

In further scenarios, as is known in the art, the messaging standard may utilize at least one data dictionary that relates to the one or more electronic messages. As is known in the art, a data dictionary may refer to a collection of data that can be used to further define one or more message definitions of one or more electronic messages associated with a messaging standard. The data included in the data dictionary may hereinafter be referred to as dictionary data. Accordingly, an associated party may utilize dictionary data and message definition data (e.g., included in one or more message schemas) in order to generate, process, and/or communicate one or more electronic messages in accordance with a messaging standard.

In such scenarios, the dictionary data relating to the one or more electronic messages may be used to define one or more data components that are included in one or more message definitions for these messages. In particular, the dictionary data may be used to define a structure, a format, and/or content for each data component, including any sub-components, as further described below. For instance, the dictionary data may indicate that a particular data component of a message definition corresponds to a complex type element when expressed using XML syntax.

Further, for such scenarios, the dictionary data may also indicate that one or more data elements are associated with the one or more electronic messages. In particular, the dictionary data may indicate that the one or more data components include the one or more data elements. For instance, the dictionary data may indicate that a specific data component of a specific message definition may include one or more particular data elements. In such an instance, each particular data element may be used to specify the data to be included in an electronic message that corresponds to the specific message definition. As is known in the art, the one or more data components and the one or more data elements associated with an electronic message may be organized in a hierarchical structure. In addition, the dictionary data may be used to define these one or more data elements associated with the one or more electronic messages. In particular, the dictionary data may be used to define a structure, a format, and/or content for each data element associated with the one or more electronic messages. For instance, the dictionary data may indicate that a particular data element corresponds to a specific data type and/or may have a specific range of data values.

A data element may correspond to any representation of a data value known in the art, where the representation may include, but may not be limited to, the following: a variable, an object, a field, a record, a data structure, and/or the like. Further, the data element may correspond to any data type known in the art, such that the data element may be associated with any data value known in the art. Such a data value may include, but may not be limited to, the following: a numerical value, a character value, a string value, a Boolean value, a value relating to an object, a value relating to a class, and/or the like. For instance, a data element associated with a message definition may correspond to a representation of an atomic data type, where the representation may be a variable corresponding to a primitive data type (e.g., an integer data type), a simple type element expressed in XML syntax, and/or the like. In another instance, a data element associated with a message definition may correspond to a representation of a composite data type, where the representation may be an object created from a class, a complex type element expressed in XML syntax, and/or the like.

As mentioned above, a particular message definition may include at least one data component, where the data component may correspond to a class (e.g., as an object of a class). In one scenario, at least one data element included in the data component may also correspond to a class (e.g., as an object of a different class). Thus, in such a scenario, the particular message definition may include at least one object of a class (i.e., the at least one data component) that also includes one or more objects of different classes (i.e., the one or more data elements). In a further scenario, the at least one data element (i.e., the object of the different class) included in the data component may also include at least one other data element, where this at least one other data element corresponds to a class (i.e., as an object of another class). Therefore, the one or more data components and the one or more data elements associated with this particular message definition may be organized in a class-based hierarchical structure. In particular, at least a portion of the one or more data components and the one or more data elements may correspond to objects of classes, such that these objects are organized in accordance with a hierarchical structure. A data dictionary relating to this particular message definition may be referred to as a class-based data dictionary, such that this data dictionary may be used to define the one or more data components and/or the one or more data elements that correspond to the one or more classes.

Similar to the message definition data described above, dictionary data that relates to one or more electronic messages of a messaging standard may be included in one or more schema documents, where such schema documents may be utilized by one or more of the associated parties mentioned above. A schema document that includes only dictionary data may hereinafter be referred to as a dictionary schema or a dictionary schema document. As is known in the art, a dictionary schema may include dictionary data relating to one or more specific messages of the messaging standard. In one instance, one or more dictionary schemas may be associated with a subset of the messages of the messaging standard, such that the one or more dictionary schemas may include dictionary data relating to the subset of the messages. In such an instance, the dictionary data may correspond to one or more data dictionaries. In another instance, one or more dictionary schemas may be associated with all messages of the messaging standard, such that the one or more dictionary schemas may include dictionary data relating to all messages of the messaging standard. In such an instance, the dictionary data may correspond to one or more data dictionaries, such as a central data dictionary. In yet another instance, one or more message schemas associated with one or more electronic messages of a messaging standard may include the dictionary data relating to the one or more messages.

Thus, an associated party may utilize one or more message schemas and/or one or more dictionary schemas in order to generate, process, and/or communicate one or more electronic messages in accordance with a messaging standard. The dictionary data included in a particular schema may be in a machine-readable format. In particular, the dictionary data may be expressed using any syntax and/or file format known to those skilled in the art, including XML, JSON, and/or the like. In one instance, as is known in the art, a dictionary schema may be an XML Schema document, where the dictionary data included in the dictionary schema may be expressed using XML. For such an instance, the dictionary schema may have “.xsd” as a filename extension.

For example, the ISO 20022 standard may utilize dictionary data relating to one or more electronic messages of the standard, such as the above-mentioned “AuthorisationInitiationV02” message. As noted above, the “AuthorisationInitiationV02” message may be utilized by a party (e.g., an acquirer) associated with a payment card transaction. Additionally, in this example, dictionary data relating to the “AuthorisationInitiationV02” message may also be included in the above-described “cain.001.001.02” message schema associated with the message, where the dictionary data may be expressed using XML syntax. In particular, the dictionary data may define the data components included in a message definition for the “AuthorisationInitiationV02” message. A portion of the dictionary data included in the “cain.001.001.02” message schema is shown below in Table 2.

```
TABLE 2
<?xml version=“1.0” encoding=“UTF-8”?>
<!--Generated by Standards Editor (build:R1.6.16) on 2020 May 26 08:54:36, ISO 20022 version :
2013-->
<xs:schema xmlns=“urn:iso:std:iso:20022:tech:xsd:cain.001.001.02”
xmlns:xs=“http://www.w3.org/2001/XMLSchema” elementFormDefault=“qualified”
targetNamespace=“urn:iso:std:iso:20022:tech:xsd:cain.001.001.02”>
. . .
  <xs:complexType name=“AuthorisationInitiation1”>
      <xs:sequence>
        <xs:element name=“Envt” type=“Environment1”/>
        <xs:element name=“Cntxt” type=“Context1”/>
        <xs:element name=“Tx” type=“Transaction77”/>
        <xs:element maxOccurs=“1” minOccurs=“0” name=“AdddmData” type=“AddendumData1”/>
        <xs:element maxOccurs=“1” minOccurs=“0” name=“ProgRslt” type=“ProcessingResult1”/>
        <xs:element maxOccurs=“1” minOccurs=“0” name=“ICCRltdData”
  type=“Max10KHexBinaryText”/>
        <xs:element maxOccurs=“unbounded” minOccurs=“0” name=“PrtctdData”
  type=“ProtectedData1”/>
        <xs:element maxOccurs=“unbounded” minOccurs=“0” name=“SplmtryData”
  type=“SupplementaryData1”/>
      </xs:sequence>
  </xs:complexType>
. . .
  <xs:complexType name=“Environment1”>
      <xs:sequence>
        <xs:element name=“Acqrr” type=“PartyIdentification197”/>
        <xs:element maxOccurs=“1” minOccurs=“0” name=“Sndr” type=“PartyIdentification197”/>
        <xs:element maxOccurs=“1” minOccurs=“0” name=“Rcvr” type=“PartyIdentification197”/>
        <xs:element maxOccurs=“1” minOccurs=“0” name=“Accptr” type=“PartyIdentification203”/>
        <xs:element maxOccurs=“1” minOccurs=“0” name=“Pyer” type=“PartyIdentification211”/>
        <xs:element maxOccurs=“1” minOccurs=“0” name=“Pyee” type=“PartyIdentification211”/>
        <xs:element maxOccurs=“1” minOccurs=“0” name=“Termnl” type=“Terminal1”/>
        <xs:element name=“Card” type=“CardData1”/>
        <xs:element maxOccurs=“1” minOccurs=“0” name=“CstmrDvc” type=“CustomerDevice2”/>
        <xs:element maxOccurs=“1” minOccurs=“0” name=“Wllt” type=“Wallet1”/>
        <xs:element maxOccurs=“1” minOccurs=“0” name=“Tkn” type=“Token1”/>
        <xs:element maxOccurs=“1” minOccurs=“0” name=“Crdhldr” type=“Cardholder15”/>
      </xs:sequence>
  </xs:complexType>
. . .
  <xs:complexType name=“CardData1”>
      <xs:sequence>
        <xs:element name=“PAN” type=“Max19NumericText”/>
        <xs:element maxOccurs=“1” minOccurs=“0” name=“PrtctdPANInd”
  type=“TrueFalseIndicator”/>
        <xs:element maxOccurs=“1” minOccurs=“0” name=“CardSeqNb”
  type=“Min2Max3NumericText”/>
        <xs:element maxOccurs=“1” minOccurs=“0” name=“FctvDt” type=“Max10Text”/>
        <xs:element maxOccurs=“1” minOccurs=“0” name=“XpryDt” type=“Exact4NumericText”/>
        <xs:element maxOccurs=“1” minOccurs=“0” name=“SvcCd” type=“Exact3NumericText”/>
        <xs:element maxOccurs=“1” minOccurs=“0” name=“Trck1” type=“Max76Text”/>
        <xs:element maxOccurs=“1” minOccurs=“0” name=“Trck2” type=“Track2Data1Choice”/>
        <xs:element maxOccurs=“1” minOccurs=“0” name=“Trck3” type=“Max104Text”/>
        <xs:element maxOccurs=“1” minOccurs=“0” name=“PmtAcctRef” type=“Max35Text”/>
        <xs:element maxOccurs=“1” minOccurs=“0” name=“CardCtryCd”
  type=“ISO3NumericCountryCode”/>
        <xs:element maxOccurs=“1” minOccurs=“0” name=“CardPdctTp” type=“Max35Text”/>
        <xs:element maxOccurs=“1” minOccurs=“0” name=“CardPdctSubTp” type=“Max35Text”/>
        <xs:element maxOccurs=“1” minOccurs=“0” name=“CardPrtflIdr” type=“Max35Text”/>
        <xs:element maxOccurs=“1” minOccurs=“0” name=“AddtlCardData” type=“Max70Text”/>
      </xs:sequence>
  </xs:complexType>
. . .
  <xs:complexType name=“Transaction77”>
      <xs:sequence>
        <xs:element name=“TxTp” type=“Exact2AlphaNumericText”/>
        <xs:element maxOccurs=“1” minOccurs=“0” name=“TxSubTp” type=“Max35Text”/>
        <xs:element maxOccurs=“unbounded” minOccurs=“0” name=“AddtlSvc”
  type=“AdditionalService1”/>
        <xs:element maxOccurs=“1” minOccurs=“0” name=“TxAttr”
  type=“TransactionAttribute1Code”/>
        <xs:element maxOccurs=“1” minOccurs=“0” name=“OthrTxAttr” type=“Max35Text”/>
        <xs:element maxOccurs=“unbounded” minOccurs=“0” name=“MsgRsn”
  type=“Exact4NumericText”/>
        <xs:element maxOccurs=“unbounded” minOccurs=“0” name=“AltrnMsgRsn”
  type=“Max35Text”/>
        <xs:element maxOccurs=“1” minOccurs=“0” name=“PreAuthstnTmLmt”
  type=“Max6NumericText”/>
        <xs:element maxOccurs=“1” minOccurs=“0” name=“AssoctdDataInd”
  type=“TrueFalseIndicator”/>
        <xs:element maxOccurs=“1” minOccurs=“0” name=“AssoctdDataRef” type=“Max70Text”/>
        <xs:element maxOccurs=“1” minOccurs=“0” name=“AssoctdDataDstn” type=“Max35Text”/>
        <xs:element maxOccurs=“unbounded” minOccurs=“0” name=“SpclPrgrmmQlfctn”
  type=“SpecialProgrammeQualification1”/>
        <xs:element name=“TxId” type=“TransactionIdentification8”/>
        <xs:element maxOccurs=“unbounded” minOccurs=“0” name=“DsptData”
  type=“DisputeData1”/>
        <xs:element name=“TxAmts” type=“TransactionAmounts1”/>
        <xs:element maxOccurs=“unbounded” minOccurs=“0” name=“AddtlAmts”
  type=“AdditionalAmounts1”/>
        <xs:element maxOccurs=“unbounded” minOccurs=“0” name=“AddtlFees”
  type=“AdditionalFee1”/>
        <xs:element maxOccurs=“unbounded” minOccurs=“0” name=“OrgnlAddtlFees”
  type=“AdditionalFee1”/>
        <xs:element maxOccurs=“unbounded” minOccurs=“0” name=“DpstDtls”
  type=“DepositDetails1”/>
        <xs:element maxOccurs=“1” minOccurs=“0” name=“FndsSvcs” type=“FundingService1”/>
        <xs:element maxOccurs=“1” minOccurs=“0” name=“AcctFr” type=“AccountDetails2”/>
        <xs:element maxOccurs=“1” minOccurs=“0” name=“AcctTo” type=“AccountDetails2”/>
        <xs:element maxOccurs=“1” minOccurs=“0” name=“TxDesc” type=“Max1000Text”/>
        <xs:element maxOccurs=“unbounded” minOccurs=“0” name=“AddtlData”
  type=“AdditionalData1”/>
      </xs:sequence>
    </xs:complexType>
. . .
</xs:schema>
```

As explained above with respect to Table 1, the message definition for the “AuthorisationInitiationV02” message may correspond to the complex type element named “AuthorisationInitiationV02.” In addition, an element (e.g., the “Body” element”) included in this complex type element may represent a data component of the message definition. As is also explained above, the “Body” element is of the type “AuthorisationInitiation1,” such that the “Body” element may correspond to an element named “AuthorisationInitiation1.”

As shown in Table 2, the dictionary data relating to the “AuthorisationInitiationV02” message may further define this “Body” element (i.e., a data component of the message definition). In particular, as shown, the dictionary data may indicate that the “AuthorisationInitiation1” element, to which the “Body” element corresponds, is a complex type element. Further, as shown, the “AuthorisationInitiation1” element may include a number of other elements, such as an “Envt” element of a type “Environment1,” a “Tx” element of a type “Transaction77,” an “AdddmData” element of a type “AddendumData1,” and so forth. Given that the “Body” element corresponds to the “AuthorisationInitiation1” element, the “Body” element may also include these elements. Specifically, these included elements may represent data elements of the “Body” element (i.e., a data component).

Further, as shown, based on the dictionary data corresponding to a complex type element named “Transaction77,” the “Tx” element (i.e., a data element of the “Body” element) may include a number of data elements, including, at least, a simple type element named “TxTp.” In addition, based on the dictionary data corresponding to a complex type element named “Environment1,” the “Envt” element (i.e., a data element of the “Body” element) may include a number of data elements, including, at least, a “Card” element of a type “CardData1.” As is also shown, based on the dictionary data corresponding to a complex type element named “CardData1,” the “Card” element (i.e., a data element of the “Envt” element) may also include a number of data elements, including, at least, a simple type element named “PAN.” In particular, this “PAN” element may be a data element associated with the message definition for the “AuthorisationInitiationV02” message, where this “PAN” element may correspond to a PAN of a payment card used in the payment card transaction. Specifically, the message definition may indicate that each “AuthorisationInitiationV02” message is to include, at least, a data value (e.g., a numerical value) for a PAN of a payment card used in a payment card transaction relating to the message.

As mentioned above, each data component (e.g., the “Body” element) of the message definition (i.e., the complex type element named “AuthorisationInitiationV02”) may correspond to a class. For instance, the “Body” element (i.e., a data component) may correspond to a class, where the class may be the complex type element named “AuthorisationInitiation1.” Specifically, the “Body” element may represent an object (i.e., an instance) created from that class. Further, a number of the data elements mentioned above may also correspond to classes. In particular, the “Envt” element may represent an object created from a class (i.e., the complex type element named “Environment1”), the “Card” element may represent an object created from a class (i.e., the complex type element named “CardData1”), and the “Tx” element may represent an object created from a class (i.e., the complex type element named “Transaction77”).

Thus, a data dictionary relating to this “AuthorisationInitiationV02” message may be referred to as a class-based data dictionary. In addition, based on the message definition data and the dictionary data included in the “cain.001.001.02” message schema, an associated party may be able to generate, process, and/or communicate the “AuthorisationInitiationV02” message in accordance with the ISO 20022 standard.

### D. Translating Electronic Messages

In other scenarios, parties associated with a business transaction may exchange electronic messages in accordance with multiple messaging standards. For instance, a first party may primarily generate, process, and/or communicate electronic messages that correspond to a first messaging standard, whereas a second party may primarily generate, process, and/or communicate electronic messages that correspond to a second, different messaging standard. Further, an electronic message communicated by the first party and an electronic message communicated by the second party may both include at least one data value (e.g., a numerical value for a PAN) that is the same. However, based on the different messaging standards, these electronic messages may have a structure, a format, and/or content that differ from one another. For example, the electronic messages communicated from the first party and the second party may differ with respect to their corresponding data elements and/or the use of a particular file format (e.g., XML, JSON, etc.). In such an instance, the first party may not be able to process an electronic message received from the second party and/or vice versa.

In these scenarios, in order to perform the business transaction, one or more of the associated parties may need to translate electronic messages corresponding to one messaging standard into electronic messages corresponding to another messaging standard. For instance, an associated party may receive electronic messages corresponding to a first messaging standard (e.g., the ISO 8583 standard). However, a second messaging standard (e.g., the ISO 20022 standard) may be more frequently used by the associated party when processing electronic messages. As a result, the associated party may translate the received electronic messages corresponding to the first messaging standard into electronic messages corresponding to the second messaging standard.

In another instance, an associated party may receive electronic messages corresponding to a first messaging standard (e.g., the ISO 20022 standard). The associated party may then translate the received electronic messages into electronic messages corresponding to an internal messaging standard, where the internal messaging standard may be used internally by the associated party in order to facilitate a processing of electronic messages. However, other associated parties may prefer electronic messages that correspond to a different messaging standard (e.g., the first messaging standard, a second messaging standard, etc.). As a result, the associated party may translate the electronic messages corresponding to the internal messaging standard into electronic messages that correspond to the different messaging standard. The associated party may then communicate the electronic messages corresponding to the different messaging standard to the other associated parties.

As is known in the art, in order to translate a first electronic message corresponding to a first messaging standard into a second electronic message corresponding to a second messaging standard, one or more data elements associated with the first electronic message may need to be mapped to one or more equivalent data elements associated with the second electronic message. In one scenario, a data element associated with the first electronic message may be equivalent to a data element associated with the second electronic message if each of these data elements represents an equivalent data value relating to the business transaction.

For example, for a payment card transaction, an associated party may receive a first electronic message corresponding to the ISO 8583 standard. Message definition data and/or dictionary data relating to this first electronic message may indicate that the message is associated with multiple data elements, including a data element referred to as “Data Element 2” or “DE2.” In particular, the “Data Element 2” may correspond to a PAN of a payment card used in the payment card transaction. In this example, the associated party may want to translate the first electronic message into a second electronic message corresponding to the ISO 20022 standard for further processing, where the second electronic message corresponds to the “AuthorisationInitiationV02” message described above. In order to translate the first electronic message into this second electronic message, the “Data Element 2” may need to be mapped to an equivalent data element associated with the “AuthorisationInitiationV02” message, where this equivalent data element corresponds to the same PAN as the “Data Element 2.” In such an example, this equivalent data element associated with the “AuthorisationInitiationV02” message may be the simple type element named “PAN” (i.e., a data element of the “Card” element) mentioned above. Based on these mapped data elements, the associated party may be able to generate the second electronic message by translating the first electronic message. In particular, a data value (e.g., a numerical value for the PAN) included in the first electronic message for the “Data Element 2” may also be included in the second electronic message for its equivalent data element (e.g., the simple type element named “PAN”).

### E. One or More Mapping Rules

In order to map one or more equivalent data elements associated with electronic messages of different messaging standards, an associated party may utilize one or more mapping rules. A mapping rule may correspond to a rule and/or instruction that is configured to map a specific data element associated with a first electronic message to another specific data element associated with a second electronic message, where these specific data elements may be equivalent to one another. As is known in the art, data corresponding to the one or more mapping rules may be included in one or more mapping documents, schemas, files, and/or the like. The data corresponding to the one or more mapping rules may hereinafter be referred to as mapping rules data.

For example, a mapping rule may be configured to map equivalent data elements associated with a first electronic message of the ISO 8583 standard and a second electronic message of the ISO 20022 standard, where the second electronic message corresponds to the “AuthorisationInitiationV02” message described above. In particular, the mapping rule may be configured to map the “Data Element 2” associated with the first electronic message to its equivalent data element (e.g., the simple type element named “PAN”) associated with the second electronic message, where both data elements may correspond to the same numerical value for a PAN. Thus, in order to perform a business transaction for the scenarios described above, one or more associated parties may need to utilize one or more mapping rules when translating the first electronic message of the first messaging standard into the second electronic message of the second messaging standard.

In further scenarios, a data dictionary associated with the first messaging standard and/or the second messaging standard may be amended. The data dictionary may be modified for any number of reasons known to those skilled in the art, including as a response to one or more government regulations, one or more industry regulations, one or more business features added for a business transaction, one or more amendments made by an entity (e.g., the ISO) associated with a messaging standard (e.g., the ISO 20022 standard), and/or the like.

In such scenarios, the data dictionary may be amended by modifying the dictionary data associated with the first and/or second messaging standards. As explained above, the dictionary data may be included in one or more schemas (e.g., one or more message schemas, one or more dictionary schemas, and/or the like) associated with the first and/or second messaging standards. Thus, the dictionary data may be modified by modifying the one or more schemas. Further, in one scenario, the dictionary data may be modified in order to modify one or more data elements associated with electronic messages of the first and/or second messaging standards. In particular, modifying the one or more data elements may include adding, removing, and/or changing the one or more data elements associated with the electronic messages.

By modifying these one or more data elements, one or more of the above-mentioned mapping rules may no longer be valid for the electronic messages of the first and second messaging standards. Therefore, based on the modified dictionary data, an associated party may need to alter the one or more mapping rules in order to correctly translate electronic messages of the first messaging standard and/or the second messaging standard. Specifically, the associated party may need to alter these one or more mapping rules to ensure their accuracy after modifying the one or more data elements associated with these electronic messages. To alter the one or more mapping rules, the associated party may need to modify the mapping rules data mentioned above. For instance, to alter (e.g., change, add, or remove) a mapping rule, the associated party may modify a portion of the mapping rules data associated with this rule.

In one scenario, however, the associated party may commit one or more errors when modifying the mapping rules data. Such errors with respect to the mapping rules data may include one or more typographical errors, one or more syntax errors, one or more formatting errors, and/or the like. In addition, as a result of such errors, one or more of the mapping rules associated with the modified mapping rules data may be incorrect. In particular, these one or more incorrect mapping rules may be configured to incorrectly map specific data elements associated with the electronic messages of the first messaging standard and the second messaging standard. In such a scenario, based on this modified mapping rules data, the associated party may later incorrectly translate an electronic message for use in a business transaction, such as by incorporating one or more incorrect data values in the incorrectly translated electronic message.

For example, an associated party may modify the mapping rules data in order to alter a particular mapping rule of the data, such that the altered mapping rule is intended to map a first data element associated with a first electronic message to a second data element associated with a second electronic message. However, when modifying the mapping rules data, the associated party may commit a typographical error with respect to the first data element associated with the first electronic message. As a result, the altered mapping rule of the modified mapping rules data may be configured to incorrectly map a misidentified data element associated with the first electronic message to the second data element associated with the second electronic message, where these data elements are not equivalent to one another. Thus, based on this modified mapping rules data, the associated party may later generate an incorrectly translated electronic message for use in a business transaction.

Accordingly, when an associated party commits one or more errors when modifying mapping rules data, the associated party may be more likely to generate one or more incorrectly translated electronic messages for use in a business transaction (e.g., by incorporating one or more incorrect data values in the one or more incorrectly translated electronic messages). These one or more incorrectly translated electronic messages may negatively impact one or more of the parties associated with the business transaction. For instance, the use of an incorrectly translated electronic message may lead to any number of issues, such as an increase in an amount of time needed to process electronic messages used in the business transaction, an increase in an amount of time needed to complete the business transaction, a greater likelihood of the business transaction being unsuccessful, and/or the like. For one or more of the parties associated with the business transaction, such issues may lead to additional expenses, increased economic costs, fewer opportunities for future business transactions, reduced business activity, and/or the like.

In view of the above, various implementations of a system and method for validating a mapping rule for messaging standards are described herein. In one implementation, parties associated with a business transaction may be capable of exchanging electronic messages in accordance with a first messaging standard and/or a second messaging standard. In such an implementation, an associated party may utilize one or more computing systems to record mapping rules data for the first messaging standard and the second messaging standard based on modified dictionary data, where recording the mapping rules data may include validating one or more mapping rules of the mapping rules data based on a path schema.

### II. System

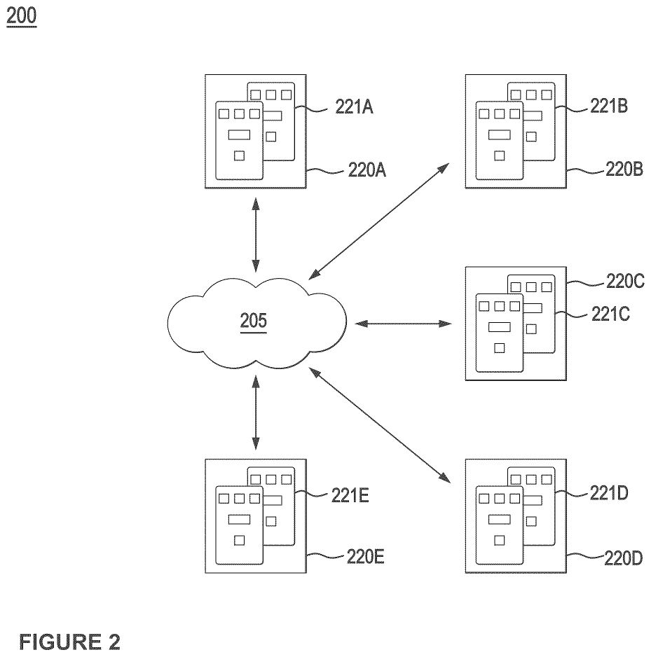

FIG. 2 illustrates a schematic diagram of a system 200 in accordance with implementations of various techniques described herein. In particular, the system 200 described herein includes automated functionalities for dynamically modifying dictionary data to reflect evolving standards, employing precise XPath traversal techniques to resolve hierarchical path ambiguities, and programmatically generating enumerated schemas to explicitly constrain permissible data elements. Furthermore, schema-compliant modeler tools within the system 200 may immediately validate mapping rules, significantly reducing errors and enhancing overall message translation reliability.

In one implementation, the system 200 may include one or more networks 205, a plurality of parties, and a plurality of computing systems. As shown, the plurality of parties may include a party 220A, a party 220B, a party 220C, a party 220D, and a party 220E. Further, as shown, the plurality of computing systems may include one or more computing systems 221A, one or more computing systems 221B, one or more computing systems 221C, one or more computing systems 221D, and one or more computing systems 221E. Each of the one or more computing systems 221A-E includes one or more processors, memory, and suitable network interfaces to facilitate communication and data exchange over the one or more networks 205. These computing systems execute program instructions to perform validation, translation, and interoperability functions.

Each party of the system 200 may each be capable of communicating with one or more other elements of the system 200 via the one or more networks 205. The one or more networks 205 may include, but may not be limited to, one or more of the following: a local area network (LAN), a wide area network (WAN) (e.g., the Internet), a mobile network, a cellular network, a virtual network, a public network, a private network, and/or any other network known in the art capable of supporting communication among two or more of the elements of the system 200.

As similarly described above, the parties of the system 200 may be associated with a business transaction, such that the parties may be capable of exchanging electronic messages (i.e., via the one or more networks 205) in accordance with a first messaging standard and/or a second messaging standard. In particular, at least one party may generate, process, and/or communicate electronic messages in accordance with the first messaging standard, whereas at least one other party may generate, process, and/or communicate electronic messages in accordance with the second messaging standard.

The business transaction associated with the system 200 may be similar to any business transaction described above. In particular, the business transaction associated with the system 200 may be any transaction relating to any business area and/or business process known to those skilled in the art. Further, each party (e.g., the parties 220A, 220B, 220C, 220D, or 220E) of the system 200 may be similar to any associated party described above, where each party may be any entity capable of performing (e.g., conducting, facilitating, and/or processing) the business transaction.

The electronic messages utilized by the system 200 may be similar to any electronic message described above. In addition, the first messaging standard and the second messaging standard may each be similar to any messaging standard mentioned above. Specifically, the first messaging standard and the second messaging standard may each specify a structure, a format, and/or content for one or more electronic messages. The first messaging standard and the second messaging standard may each be any messaging standard known to those skilled in the art, including, but not limited to, the following: the ISO 20022 standard, the ISO 8583 standard, the ISO 15022 standard, the SWIFT MT standards, the FIX standard, and/or the like. However, the first messaging standard and the second messaging standard may be different from one another. In a further implementation, either the first messaging standard or the second messaging standard may be an internal messaging standard, where the internal messaging standard may be used internally by a party of the system 200 in order to facilitate a processing of the electronic messages.

In one example, the business transaction associated with the system 200 may be a payment card transaction, which may be similar to the payment card transaction described above. As explained above, such a payment card transaction may follow a four-party model, including the four-party model 100 of FIG. 1. In such an example, the parties of the system 200 may include a cardholder, a merchant, an acquirer, a payment network, and an issuer. For instance, the party 220A may correspond to the cardholder, the party 220B may correspond to the merchant, the party 220C may correspond to the acquirer, the party 220D may correspond to the payment network, and the party 220E may correspond to the issuer. Further, as described above, the parties of the system 200 may utilize the electronic messages to communicate payment card data, payment card transaction data, authorization request data, authorization response data, verification information, and/or the like. Further, in such an example, the first messaging standard may be the ISO 20022 standard, and the second messaging standard may be the ISO 8583 standard.

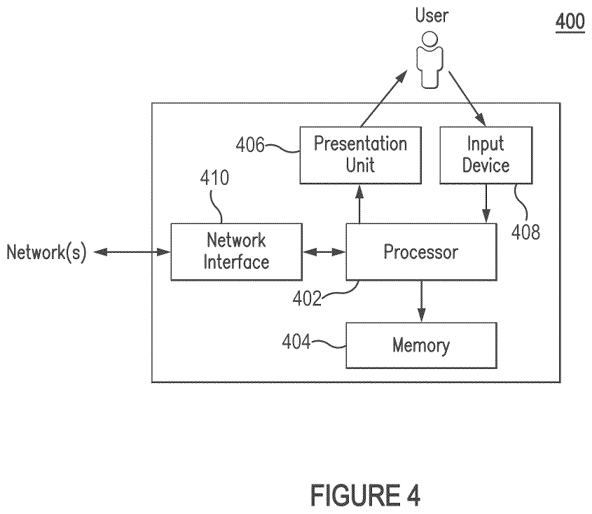

In addition, each party of the system 200 may utilize one or more computing systems to perform the business transaction, such as by using the one or more computing systems to generate, process, and/or communicate electronic messages. As shown, the party 220A may utilize the one or more computing systems 221A, the party 220B may utilize the one or more computing systems 221B, the party 220C may utilize the one or more computing systems 221C, the party 220D may utilize the one or more computing systems 221D, and the party 220E may utilize the one or more computing systems 221E. The one or more computing systems of the system 200 may each include any number and/or type of computing systems known to those skilled in the art, such as one or more servers, one or more mobile devices (e.g., one or more smartphones), one or more wearable devices (e.g., one or more smartwatches), one or more tablet devices, one or more laptop computing devices, one or more desktop computing devices, one or more merchant servers, one or more POS devices, one or more ATMs, one or more point-of-interaction (POI) devices, one or more point-of-purchase (POP) devices, one or more edge devices, and/or the like. Various implementations of the one or more computing systems of the system 200 are discussed later with respect to FIG. 4.

As further explained below, at least one party (e.g., the party 220A, 220B, 220C, 220D, and/or 220E) of the system 200 may perform (i.e., via respective one or more computing systems) one or more operations described herein, including performing (e.g., conducting, facilitating, and/or processing) the business transaction. In particular, the at least one party may (i.e., via the respective one or more computing systems) generate, process, and/or communicate the electronic messages in accordance with the first messaging standard and/or the second messaging standard. Specifically, the at least one party may (i.e., via the respective one or more computing systems) record mapping rules data for the first messaging standard and the second messaging standard based on modified dictionary data, where recording the mapping rules data may include validating one or more mapping rules of the mapping rules data based on a path schema.

The one or more computing systems of the system 200 may be implemented using one or more software-based systems, one or more hardware-based systems, or combinations thereof. Further, the one or more computing systems of the system 200 may be configured to perform the one or more operations described herein using one or more applications downloaded using, installed on, and/or operated by these one or more computing systems. For example, these one or more applications may include one or more modeler tools, which may include any tool known in the art that is configured to format, map, and/or process data relating to an electronic message and/or a messaging standard. For example, the one or more modeler tools may include, but may not be limited to, one or more of the following: an editing tool, a transformations tool, a document processing and/or management tool, a schema editor tool, a modeling tool, a graphical editing tool, a text-based editing tool, a logical editing tool, a validation tool, an integrated development environment (IDE) software application, and/or the like.

In addition, the one or more computing systems of the system 200 may communicate with one another using any technique known to those skilled in the art. For example, though not shown in FIG. 2, the one or more computing systems (e.g., the one or more computing systems 221A, 221B, 221C, 221D, and 221E) of the system 200 may communicate with one another using one or more application programming interfaces (APIs) associated with the one or more applications mentioned above. In another example, the one or more applications used by at least some of the computing systems of the system 200 may include a web browser, such that the web browser may be used to communicate with other computing systems of the system 200 via the one or more networks 205.

Further, although the system 200 is presented in one arrangement, other implementations may include one or more elements of the system 200 in different arrangements and/or with additional elements. For example, though the plurality of parties of the system 200 is shown as including five parties (e.g., the parties 220A, 220B, 220C, 220D, and 220E) in FIG. 2, those skilled in the art will understand that the implementations described herein may involve any number of parties that are capable of performing a business transaction. In another example, though the plurality of computing systems of system 200 is shown in FIG. 2 as including the one or more computing systems 221A, 221B, 221C, 221D, and 221E, those skilled in the art will understand that the implementations described herein may involve any number of computing systems for use by the parties.

Moreover, while a payment card transaction is discussed above, those skilled in the art will understand that implementations of the system 200 may be associated with any type of business transaction known in the art, where such a business transaction may involve any number of associated parties and/or any number of computing systems that are capable of exchanging electronic messages. For example, the business transaction may be a bank services transaction between a financial institution (e.g., a bank) and a customer (e.g., a bank account holder), a financial investigations transaction between a financial institution (e.g., a bank) and a government agency, a management transaction between an ATM and a financial institution (e.g., a bank), and/or the like.

In various implementations, the computing systems described herein implement specific technical processes to enhance authentication and validation during electronic message translation and mapping. For example, the mapping rules recorded by these systems are subjected to automated validation processes that include cryptographic hashing, digital signatures, or other cryptographic mechanisms to authenticate the integrity and authenticity of dictionary data, path schemas, and mapping rules data. By incorporating these cryptographic validation procedures, the described systems significantly enhance the reliability and trustworthiness of message translations, ensuring data integrity and reducing vulnerabilities inherent in traditional manual mapping and translation methods.

Further, the computing systems are configured to utilize secure communication protocols, such as Transport Layer Security (TLS), Secure Sockets Layer (SSL), or other encrypted communication methods, to securely exchange dictionary data, message definitions, path schemas, and mapping rules data between the various computing entities. Implementing these secure communication channels substantially mitigates risks associated with data interception, tampering, and unauthorized access, thereby safeguarding sensitive financial and business transaction data throughout the translation and mapping processes.

Additionally, certain implementations described herein enable secure data storage and access through the employment of secure, restricted-access databases or encrypted data stores. Specifically, dictionary data, schema definitions, and mapping rules data may be stored within encrypted databases, accessed exclusively through authenticated and authorized channels. Such implementations may employ role-based access controls (RBAC), multi-factor authentication (MFA), or biometric authentication techniques to rigorously control access to sensitive data elements and translation resources, thus enhancing the overall security posture and operational robustness of the transaction-processing environment.

Accordingly, the technical mechanisms described herein (e.g., such as cryptographic validation of mapping rules, secure encrypted communication protocols, secure storage, and rigorous access control techniques) not only address shortcomings in conventional manual translation approaches but also provide a substantial improvement to computer security and operational efficiency. Consequently, these inventive enhancements tangibly reduce the likelihood of fraudulent, erroneous, or unauthorized transactions, enabling more secure and reliable electronic message handling within financial and business transaction systems.

### III. Operation

One or more elements of the system 200 may be used to perform one or more operations described herein, including validating one or more mapping rules for a first messaging standard and a second messaging standard. In one implementation, a party (e.g., the parties 220A, 220B, 220C, 220D, or 220E) of the system 200 may utilize one or more computing systems (e.g., the one or more computing systems 221A, 221B, 221C, 221D, or 221E) to record mapping rules data for the first messaging standard and the second messaging standard based on modified dictionary data, where the modified dictionary data may relate to the first messaging standard. In such an implementation, recording the mapping rules data may include validating one or more mapping rules of the mapping rules data based on a path schema.

### A. Receiving Data

As explained above, the parties of the system 200 may be associated with a business transaction, where the parties may be (i.e., via their respective one or more computing systems) capable of exchanging one or more electronic messages associated with the first messaging standard and/or the second messaging standard. The one or more electronic messages associated with the first messaging standard and/or the second messaging standard may include any electronic message known in the art, including any electronic message mentioned above. An electronic message associated with the first messaging standard may hereinafter be referred to as a first message or a first electronic message, and an electronic message associated with the second messaging standard may hereinafter be referred to as a second message or a second electronic message.

As noted above, the first messaging standard and the second messaging standard may be different from one another. In particular, at least one party of the system 200 may generate, process, and/or communicate electronic messages in accordance with the first messaging standard, whereas at least one other party of the system 200 may generate, process, and/or communicate electronic messages in accordance with the second messaging standard. Further, the first messaging standard and the second messaging standard may each be any messaging standard known to those skilled in the art, including any messaging standard mentioned above. In one example, the first messaging standard may be the ISO 20022 standard, and the second messaging standard may be the ISO 8583 standard. In another example, the first messaging standard may be an internal messaging standard, where the internal messaging standard may be used internally by an associated party in order to facilitate a processing of electronic messages.

In some implementations, before a party (e.g., the parties 220A, 220B, 220C, 220D, or 220E) of the system 200 can record the mapping rules data mentioned above, the party may need to receive data associated with the first messaging standard. In particular, the party of the system 200 may utilize its one or more computing systems (e.g., the one or more computing systems 221A, 221B, 221C, 221D, or 221E) to receive this data associated with the first messaging standard. As explained above, the party of the system 200 may be associated with a business transaction, which may be any transaction relating to any business area and/or business process known to those skilled in the art. For example, the business transaction may be a payment card transaction. In such an example, the associated party may be a payment network (e.g., the party 220D), such that the payment network may utilize its one or more computing systems (e.g., the one or more computing systems 221D) to receive the data associated with the first messaging standard.

### 1. First Message Definition Data

For such implementations, the received data may include message definition data for one or more first messages of the first messaging standard. Such data may hereinafter be referred to as first message definition data. As similarly described above, the associated party may (i.e., via its one or more computing systems) receive the first message definition data by receiving one or more message schemas that include the data. A message schema that includes the first message definition data may hereinafter be referred to as a first message schema. The one or more first message schemas may be similar to any message schema described above.

The first message definition data may be similar to any message definition data described above. In particular, the first message definition data may relate to one or more message definitions for the one or more first messages. These one or more message definitions may hereinafter be referred to as one or more first message definitions, where the one or more first message definitions may be similar to any message definition mentioned above. In addition, as similarly explained above, a first message definition may be composed of one or more data components, where these one or more data components may hereinafter be referred to as one or more first data components. The one or more first data components may be similar to any data component mentioned above. For instance, each first data component may correspond to a class.

In one implementation, the first message definition data received by the associated party may correspond to a specific first message, such that the received first message definition data relates to only a first message definition for this specific first message. Further, as explained above, the associated party may (i.e., via its one or more computing systems) receive this first message definition data by receiving a first message schema that includes the data. In one example, where the first messaging standard corresponds to the ISO 20022 standard, the associated party may use its one or more computing systems to receive first message definition data that specifically corresponds to the “AuthorisationInitiationV02” message (i.e., a first message) mentioned above. In such an example, the associated party may (i.e., via its one or more computing systems) receive this data by receiving the “cain.001.001.02” message schema (i.e., a first message schema) that includes the data, as described above with respect to Table 1.

In another implementation, the first message definition data received by the associated party may correspond to a plurality of first messages, such that the received first message definition data relates to the plurality of first message definitions of these first messages. Moreover, as similarly explained above, the associated party may (i.e., via its one or more computing systems) receive this first message definition data by receiving one or more first message schemas that include the data. In one such implementation, a particular first message schema received by associated party (i.e., via its one or more computing systems) may include first message definition data for multiple first messages of the plurality of first messages.

In one example, the ISO 20022 standard (i.e., the first messaging standard) may be associated with hundreds of electronic messages (i.e., the multiple first messages). In this example, the associated party may use its one or more computing systems to receive message definition data (i.e., first message definition data) for each message (e.g., the “AuthorisationInitiationV02” message) associated with the ISO 20022 standard. To do so, the associated party may (i.e., via its one or more computing systems) receive one or more message schemas (i.e., one or more first message schemas) that include this data, such as the “cain.001.001.02” message schema described above.

In another example, the ISO 20022 standard (i.e., the first messaging standard) may be associated with a number of business domains, such as a Payments Domain, a Securities Domain, a Trade Finance Domain, a Cards Domain, and so forth. In particular, each business domain may correspond to a subset of electronic messages associated with the ISO 20022 standard. As is known in the art, the Cards Domain may correspond to a specific subset of electronic messages (i.e., the multiple first messages) that may be utilized for, at least, payment card transactions. In this example, for the Cards Domain, the associated party may use its one or more computing systems to receive message definition data (i.e., first message definition data) for each message (e.g., the “AuthorisationInitiationV02” message) corresponding to the Cards Domain. To do so, the associated party may (i.e., via its one or more computing systems) receive one or more message schemas (i.e., one or more first message schemas) that include this data, such as the “cain.001.001.02” message schema described above.

In yet another example, the ISO 20022 standard (i.e., the first messaging standard) may be associated with a number of message sets, such as an Acquirer to Issuer Card Messages (ATICA) message set, a Bank Account Management message set, a Card Payments Exchange-Acceptor to Acquirer message set, a Cash Management message set, and so forth. In particular, each message set may correspond to a subset of electronic messages associated with the ISO 20022 standard. As is known in the art, the ATICA message set may be associated with the Cards Domain mentioned above, such that the ATICA message set may correspond to a specific subset of electronic messages (i.e., the multiple first messages) that may be utilized for, at least, payment card transactions. In this example, for the ATICA message set, the associated party may use its one or more computing systems to receive message definition data (i.e., first message definition data) for each message corresponding to the ATICA message set. As is known in the art, such messages may include the “AuthorisationInitiationV02” message, a “BatchManagementInitiationV01” message, a “FeeCollectionInitiationV01” message, and so forth. To receive this message definition data, the associated party may (i.e., via its one or more computing systems) receive one or more message schemas (i.e., one or more first message schemas) that include the data. As is known in the art, these one or more messages schemas may include the “cain.001.001.02” message schema for the “AuthorisationInitiationV02” message, a “caad.001.001.01” message schema for the “BatchManagementInitiationV01” message, a “cafc.001.001.01” message schema for the “FeeCollectionInitiationV01” message, and so forth.

In another example, the ISO 20022 standard (i.e., the first messaging standard) may be associated with a number of business areas, where each business area corresponds to at least a portion of a message set described above. For the ATICA message set, such business areas may include an Acquirer to Issuer Card Transactions (CAIN) business area, a Card Administration (CAAD) business area, a Fee Collection (CAFC) business area, a Network Management (CANM) business area, a File Management (CAFM) business area, and so forth. In particular, each business area of a message set may correspond to a subset of electronic messages (i.e., the multiple first messages) associated with the ISO 20022 standard. In this example, for the CAIN business area of the ATICA message set, the associated party may use its one or more computing systems to receive message definition data (i.e., first message definition data) for each message that corresponds to the CAIN business area. As is known in the art, such messages may include the “AuthorisationInitiationV02” message, a “AuthorisationResponseV02” message, a “FinancialInitiationV02” message, and so forth.

To receive this message definition data, the associated party may (i.e., via its one or more computing systems) receive one or more message schemas (i.e., one or more first message schemas) that include the data. In some instances, as is known in the art, these one or more messages schemas (i.e., one or more first message schemas) may include the “cain.001.001.02” message schema for the “AuthorisationInitiationV02” message, a “cain.002.001.02” message schema for the “AuthorisationResponseV02” message, a “cain.003.001.02” message schema for the “FinancialInitiationV02” message, and so forth. In other instances, these one or more message schemas (i.e., one or more first message schemas) may correspond to a single message schema, where the single message schema includes the message definition data (i.e., the first message definition data) for each message of the CAIN business area. A portion of such a message schema is shown below in Table 3, where the message schema may be an XML Schema document. As shown in Table 3, this message definition data of this schema may be expressed using XML.

```
TABLE 3
<?xml version=“1.0”?>
<xs:schema xmlns:xs=“http://www.w3.org/2001/XMLSchema”>
<xs:include schemaLocation=“dictionary.atica2.xsd”/>
  <xs:complexType name=“AuthorisationInitiationV02”>
    <xs:sequence>
      <xs:element name=“Hdr” type=“Header42”/>
      <xs:element name=“Body” type=“AuthorisationInitiation1”/>
      <xs:element maxOccurs=“1” minOccurs=“0” name=“SctyTrlr”
  type=“ContentInformationType20”/>
    </xs:sequence>
  </xs:complexType>
  <xs:complexType name=“AuthorisationResponseV02”>
    <xs:sequence>
      <xs:element name=“Hdr” type=“Header42”/>
      <xs:element name=“Body” type=“AuthorisationInitiation1”/>
      <xs:element maxOccurs=“1” minOccurs=“0” name=“SctyTrlr”
  type=“ContentInformationType20”/>
    </xs:sequence>
  </xs:complexType>
  <xs:complexType name=“FinancialInitiationV02”>
    <xs:sequence>
      <xs:element name=“Hdr” type=“Header42”/>
      <xs:element name=“Body” type=“AuthorisationInitiation1”/>
      <xs:element maxOccurs=“1” minOccurs=“0” name=“SctyTrlr”
  type=“ContentInformationType20”/>
    </xs:sequence>
  </xs:complexType>
. . .
</xs:schema>
```

As explained above, this message schema (i.e., the first message schema) may include message definition data (i.e., first message definition data) for, at least, the following first messages: the “AuthorisationInitiationV02” message, the “Authorisation ResponseV02” message, and the “FinancialInitiationV02” message. As shown in the message schema of Table 3, a message definition (i.e., a first message definition) for the “AuthorisationInitiationV02” message may correspond to a complex type element named “AuthorisationInitiationV02,” a message definition (i.e., a first message definition) for the “AuthorisationResponseV02” message may correspond to a complex type element named “AuthorisationResponseV02,” and a message definition (i.e., a first message definition) for the “FinancialInitiationV02” message may correspond to a complex type element named “FinancialInitiationV02.” In addition, as shown, each of these complex type elements may include a “Hdr” element of a type “Header42,” a “Body” element of a type “AuthorisationInitiation1,” and a “SctyTrlr” element of a type “ContentInformationType20.” In particular, the “Hdr,” “Body,” and “SctyTrlr” elements may correspond to data components (i.e., first data components) of each message definition for the messages. Further, as explained above, these data components may also correspond to classes.

Thus, in view of the above, the associated party of the system 200 may use its one or more computing systems to receive first message definition data for any number of first messages of the first messaging standard. In particular, the associated party may (i.e., via its one or more computing systems) receive this first message definition data by receiving one or more first message schemas that include the data.

### 2. First Dictionary Data

In addition, for these implementations, the received data associated with the first messaging standard may include dictionary data relating to one or more first messages of the first messaging standard. The dictionary data relating to the one or more first messages of the first messaging standard may hereinafter be referred to as first dictionary data, and a data dictionary associated with this data may hereinafter be referred to as a first data dictionary. Thus, the received data associated with the first messaging standard may include both the first message definition data and the first dictionary data.

The first dictionary data may be similar to any dictionary data mentioned above, such that the first dictionary data can be used to further define the one or more first message definitions of the one or more first messages. As similarly described above, the first dictionary data may be used to define the one or more first data components of the one or more first message definitions. Specifically, the first dictionary data can be used to define a structure, a format, and/or content for each of these first data components. In addition, the first dictionary data may also indicate that one or more data elements are associated with the one or more first messages. In particular, the first dictionary data may indicate that the one or more first data components include the one or more data elements, where these one or more data elements may hereinafter be referred to as one or more first data elements. The one or more first data elements may be similar to any data element mentioned above.

In addition, the first dictionary data may be used to define each of these first data elements, such as where the first dictionary data may indicate that a particular first data element corresponds to a specific data type and/or may have a specific range of data values. Thus, the first dictionary data may be used to define one or more first data components and/or one or more first data elements associated with the one or more first messages. Further, as similarly explained above, at least one first data element included in a first data component of a first message definition may correspond to a class. Accordingly, the one or more first data components and the one or more first data elements associated with a particular first message may be organized in a class-based hierarchical structure, as similarly described above. In addition, the first data dictionary may be referred to as a class-based data dictionary.

Further, the associated party may (i.e., via its one or more computing systems) receive the first dictionary data by receiving one or more schemas that include such data. As explained above, these one or more schemas may include any schema known in the art, including one or more first message schemas, one or more dictionary schemas, and/or the like. A dictionary schema that includes the first dictionary data may hereinafter be referred to as a first dictionary schema. The one or more first dictionary schemas may be similar to any dictionary schema described above.

In one implementation, the first dictionary data received by the associated party may relate to a specific first message, such that the received first dictionary data relates to only a first message definition for this specific first message. In particular, this first dictionary data may be used to define one or more first data components and one or more first data elements associated with the first message definition of this specific first message. Further, as explained above, the associated party may (i.e., via its one or more computing systems) receive this first dictionary data by receiving a schema that includes the data. In one example, where the first messaging standard corresponds to the ISO 20022 standard, the associated party may use its one or more computing systems to receive first dictionary data that specifically relates to the “AuthorisationInitiationV02” message (i.e., a first message) mentioned above. In this example, the associated party may (i.e., via its one or more computing systems) receive this first dictionary data by receiving the “cain.001.001.02” message schema that includes the data, as described above with respect to Table 2.

In another implementation, the first dictionary data received by the associated party may relate to a plurality of first messages of the first messaging standard. In particular, this first dictionary data may be used to define the first data components and the first data elements associated with the first message definitions of these first messages. Moreover, as similarly explained above, the associated party may (i.e., via its one or more computing systems) receive this first dictionary data by receiving one or more schemas that include the data. In one such implementation, a specific schema may include first dictionary data that corresponds to multiple first messages of the plurality of first messages.

In one example, the ISO 20022 standard (i.e., the first messaging standard) may be associated with hundreds of electronic messages (i.e., the multiple first messages). As is known in the art, the dictionary data (i.e., the first dictionary data) that relates to these messages may correspond to a central data dictionary associated with the ISO 20022 standard. In this example, the associated party may use its one or more computing systems to receive dictionary data (i.e., first dictionary data) that relates to each message (e.g., the “AuthorisationInitiationV02” message) associated with the ISO 20022 standard. To do so, the associated party may (i.e., via its one or more computing systems) receive one or more schemas that include this dictionary data. In one instance, the one or more schemas may include at least one dictionary schema (i.e., a first dictionary schema) that includes this dictionary data. In another instance, the one or more schemas may include one or more message schemas that include this dictionary data, such as the “cain.001.001.02” message schema discussed above. In particular, as shown above in Table 2, this message schema may include the dictionary data that relates to the “AuthorisationInitiationV02” message (i.e., a first message).

In another example, the ISO 20022 standard may be associated with various subsets of electronic messages (i.e., the multiple first messages). As explained above, a subset of electronic messages may include electronic messages (i.e., the multiple first messages) that correspond to a business domain (e.g., the Cards Domain), a message set (e.g., the ATICA message set), a business area (e.g., the CAIN business area of the ATICA message set), and/or the like. In this example, the associated party may use its one or more computing systems to receive dictionary data (i.e., first dictionary data) that relates to a specific subset of the electronic messages associated with the ISO 20022 standard. To do so, the associated party may (i.e., via its one or more computing systems) receive one or more schemas that include this dictionary data.

In one such example, for the CAIN business area of the ATICA message set, the associated party may use its one or more computing systems to receive dictionary data (i.e., first dictionary data) for electronic messages (i.e., the multiple first messages) that correspond to the CAIN business area. As explained above with respect to Table 3, the CAIN business area of the ATICA message set may correspond to messages that include, at least, the “AuthorisationInitiationV02” message, the “AuthorisationResponseV02” message, the “FinancialInitiationV02” message, and so forth. Thus, for such an example, the dictionary data may be used to define one or more data components (i.e., one or more first data components) and one or more data elements (i.e., one or more first data elements) associated with these messages. Such dictionary data may be similar to the dictionary data shown above in Table 2. To receive this dictionary data, the associated party may (i.e., via its one or more computing systems) receive one or more schemas that include the data. In one instance, the one or more schemas may include at least one dictionary schema (i.e., a first dictionary schema) that includes this dictionary data. In another instance, the one or more schemas may include one or more message schemas that include this dictionary data. As explained above, these message schemas may include the “cain.001.001.02” message schema, the “cain.002.001.02” message schema, the “cain.003.001.02” message schema, and so forth.

Thus, in view of the above, the associated party of the system 200 may use its one or more computing systems to receive first dictionary data for any number of first messages of the first messaging standard. In particular, the associated party may (i.e., via its one or more computing systems) receive this first dictionary data by receiving one or more schemas that include the data.

3. Data Associated with Second Messaging Standard

In further implementations, the associated party of the system 200 may utilize its one or more computing systems to also receive data associated with the second messaging standard. For such implementations, this received data may include data relating to one or more message definitions of one or more second messages associated with the second messaging standard. These one or more message definitions may hereinafter be referred to as one or more second message definitions. The data relating to the one or more second message definitions may hereinafter be referred to as second message definition data.

In addition, the data received by the associated party (i.e., via its one or more computing systems) may include dictionary data relating to the one or more second messages, where this dictionary data may hereinafter be referred to as second dictionary data. The second dictionary data can be used to further define the one or more second message definitions of the one or more second messages. As similarly explained above, the second dictionary data may be used to define one or more data components and/or one or more data elements associated with the one or more second messages. These one or more data components may hereinafter be referred to as one or more second data components, and these one or more data elements may hereinafter be referred to as one or more second data elements.

### 4. One or More Modeler Tools

Furthermore, for some implementations disclosed herein, the associated party of the system 200 may (i.e., via its one or more computing systems) utilize one or more modeler tools in order to perform one or more operations described herein, including receiving the data associated with the first and/or second messaging standards. As noted above, such data may include, at least, first dictionary data relating to one or more first messages of a first messaging standard. The one or more modeler tools may be downloaded using, installed on, and/or operated by the one or more computing systems utilized by the associated party. The one or more modeler tools may include any tool mentioned above. In particular, the one or more modeler tools may include any tool known in the art that may be configured to format, map, and/or process data relating to an electronic message and/or a messaging standard.

Additionally, in one implementation, to receive the data associated with the first and/or second messaging standards as described above, the associated party of the system 200 may (i.e., via its one or more computing systems) retrieve the data from one or more databases of its one or more computing systems. In such an implementation, the one or more databases may be located in one or more storage media associated with the one or more computing systems. For example, an associated party may use its one or more computing systems to retrieve first dictionary data relating to one or more first messages of a first messaging standard from its one or more databases.

In another implementation, to receive the data associated with the first and/or second messaging standards as described above, the associated party of the system 200 may (i.e., via its one or more computing systems) acquire the data from one or more external computing systems (not shown in FIG. 2). In such an implementation, the associated party may utilize a web browser and/or other applications (e.g., the one or more modeler tools) installed on and/or operated by its one or more computing systems in order to communicate with the one or more external computing systems (i.e., via the one or more networks 205). For example, a third-party entity operating and/or providing the one or more external computing systems may provide and/or host a web portal through which an associated party may (i.e., via its one or more computing systems) acquire first dictionary data relating to one or more first messages of a first messaging standard.

### B. Modifying First Dictionary Data

As discussed above, the first dictionary data may relate to the one or more first messages of the first messaging standard, such that the first dictionary data can be used to further define the one or more first message definitions of these first messages. In particular, the first dictionary data may be used to define the one or more first data components of these one or more first message definitions. In addition, the first dictionary data may indicate that one or more first data elements are associated with the one or more first messages. Specifically, the first dictionary data may indicate that the one or more first data components include the one or more first data elements. Further, the first dictionary data may be used to define each of these first data elements, such as by indicating that a particular first data element corresponds to a specific data type and/or may have a specific range of data values.

In some implementations, after receiving this first dictionary data relating to the one or more first messages of the first messaging standard, the associated party of the system 200 may utilize its one or more computing systems to modify the first dictionary data. As noted above, the first dictionary data may be modified for any number of reasons. For instance, the associated party of the system 200 may (i.e., via its one or more computing systems) modify the first dictionary data in response to one or more of the following: one or more government regulations, one or more industry regulations, one or more amendments made by an entity (e.g., the ISO) associated with a messaging standard (e.g., the ISO 20022 standard), one or more business features (e.g., one or more new anti-fraud features) being employed for a business transaction, and/or the like.

In one such implementation, the associated party of the system 200 may (i.e., via its one or more computing systems) modify the first dictionary data in order to modify one or more first data elements associated with the one or more first messages. In particular, modifying the one or more first data elements may include adding, removing, and/or changing the one or more first data elements associated with the one or more first messages. For instance, the associated party of the system 200 may (i.e., via its one or more computing systems) modify the first dictionary data in order to change a range of data values associated with a specific first data element of a particular first message. Further, the modified first dictionary data may indicate that its one or more first data elements are associated with the one or more first messages. Specifically, the modified first dictionary data may indicate that a particular first message may be associated with one or more specific first data elements, where at least one specific first data element had been modified by the associated party when modifying the first dictionary data.

As mentioned above, the first dictionary data may be included in one or more schemas (e.g., one or more message schemas, one or more dictionary schemas, and/or the like) associated with the first messaging standard. Thus, the first dictionary data may be modified by modifying these one or more schemas. As noted above, the first dictionary data included in a particular schema may be in a machine-readable format. In particular, the first dictionary data may be expressed using any syntax and/or file format known to those skilled in the art. For instance, the first dictionary data included in a particular schema may be expressed using XML, JSON, and/or the like.

In a further implementation, the associated party may (i.e., via its one or more computing systems) utilize the one or more modeler tools mentioned above in order to modify the first dictionary data. For instance, where the first dictionary data is included in a particular schema, the one or more modeler tools may be configured to modify the schema in order to modify the first dictionary data.

In one example, where the first messaging standard is the ISO 20022 standard, the associated party of the system 200 may use its one or more computing systems to modify first dictionary data that relates to the “AuthorisationInitiationV02” message (i.e., a first message) described above. This first dictionary data may correspond to, at least, the dictionary data shown in Table 2. As explained above with respect to Table 2, the first dictionary data may be included in the “cain.001.001.02” message schema mentioned above (e.g., a first message schema), where this first dictionary data may be expressed using XML syntax. Further, as is also explained above with respect to Table 2, the first dictionary data relating to the “AuthorisationInitiationV02” message may indicate that a number of first data elements are associated with this message. For instance, the first dictionary data may indicate that the “Body” element (i.e., a first data component) of the message includes multiple first data elements, such as an “Envt” element of a type “Environment1,” a “Tx” element of a type “Transaction77,” an “AdddmData” element of a type “AddendumData1,” and so forth. In addition, as shown in Table 2, the first dictionary data may indicate that the “Tx” element (i.e., a first data element of the “Body” element) includes a number of first data elements, including, at least, a simple type element named “TxTp.” Further, as shown in Table 2, the first dictionary data may indicate that the “Envt” element (i.e., a first data element of the “Body” element) includes a number of first data elements, including, at least, a “Card” element of a type “CardData1.” As is also shown in Table 2, the first dictionary data may indicate that this “Card” element also includes a number of first data elements, including, at least, a simple type element named “PAN.”

In such an example, the associated party of the system 200 may use its one or more computing systems to modify the first dictionary data relating to the “AuthorisationInitiationV02” message, such as by modifying the “cain.001.001.02” message schema. In particular, the party may modify this first dictionary data in order to modify one or more specific first data elements associated with the “AuthorisationInitiationV02” message. In one instance, the associated party may (i.e., via its one or more computing systems) modify the first dictionary data shown in Table 2 in order to change a range of numerical values associated with the “PAN” element. In another instance, the associated party may (i.e., via its one or more computing systems) modify the first dictionary data shown in Table 2 in order to add a first data element to the “Card” element described above.

Thus, in view of the above, an associated party of the system 200 may use its one or more computing systems to modify first dictionary data that relates to one or more first messages of a first messaging standard. In particular, the associated party may (i.e., via its one or more computing systems) modify the first dictionary data in order to modify the one or more first data elements associated with these first messages. In some instances, the associated party may (i.e., via its one or more computing systems) modify the first dictionary data by modifying one or more schemas that include the data.

In a further implementation, the associated party of the system 200 may utilize its one or more computing systems to similarly modify second dictionary data that relates to one or more second messages of the second messaging standard. In other implementations, the associated party of the system 200 may utilize its one or more computing systems to receive the modified first dictionary data and/or the modified second dictionary data, such as where the first and/or second dictionary data had been modified by another entity. In one implementation, the entity may be unrelated to any of the parties of system 200. For such an implementation, the associated party of the system 200 may (i.e., via its one or more computing systems) receive the modified first and/or second dictionary data by acquiring the modified data from the entity. In particular, as similarly described above, the associated party of the system 200 may (i.e., via its one or more computing systems) acquire the modified first and/or second dictionary data from one or more external computing systems associated with the entity, such as via a web portal. In one example, the entity may be a standards organization (e.g., the ISO) associated with the first messaging standard (e.g., the ISO 20022 standard), and the associated party may utilize its one or more computing systems to receive the modified first dictionary data from one or more external computing systems associated with the standards organization.

### C. Determining One or More Paths

As discussed above, the associated party of the system 200 may use its one or more computing systems to modify the first dictionary data relating to the one or more first messages of the first messaging standard. In particular, the associated party may (i.e., via its one or more computing systems) modify the first dictionary data in order to modify (e.g., add, remove, and/or change) the one or more first data elements associated with the one or more first messages. Further, as explained above, the modified first dictionary data may indicate that a particular first message is associated with one or more specific first data elements, where at least one specific first data element had been modified when modifying the first dictionary data.

After modifying the first dictionary data relating to the one or more first messages as described above, the associated party of the system 200 may (i.e., via its one or more computing systems) use the modified first dictionary data to identify the one or more first data elements that are associated with these one or more first messages. In some implementations, to identify these first data elements, the associated party may (i.e., via its one or more computing systems) use the modified first dictionary data to determine one or more paths for, at least, the one or more first data elements associated with the one or more first messages.

Each particular first data element associated with a specific first message may correspond to a specific path, such that the specific path may be used to identify, locate, and/or access that particular first data element associated with the specific first message. A path that corresponds to a first data element associated with a first message may be any type of path known in the art, such as a location path for this first data element. As is known in the art, a location path for a first data element may correspond to a sequence of location steps for use in identifying, locating, and/or accessing the first data element. A path may also be referred to herein as a path expression, such that these terms may be used interchangeably.

In addition, the associated party may (i.e., via its one or more computing systems) also use the first message definition data of the one or more first messages to determine these one or more paths for the one or more first data elements. Thus, the associated party may use both the modified first dictionary data and the first message definition data in order to determine these one or more paths for the one or more first data elements. Furthermore, the associated party may (i.e., via its one or more computing systems) use the first message definition data to determine one or more paths for the one or more first data components associated with these first messages, where each specific first data component may similarly correspond to a specific path. Accordingly, in view of the above, the associated party may (i.e., via its one or more computing systems) use both the modified first dictionary data and the first message definition data when determining the one or more paths, where these one or more paths may correspond to the one or more first data components and/or the one or more first data elements associated with these first messages.

### 1. Hierarchical Structure

In one such implementation, the associated party of the system 200 may (i.e., via its one or more computing systems) determine such paths associated with a specific first message based on a hierarchical structure corresponding to this message. As explained above, the first message definition data and the modified first dictionary data relating to the message may indicate that one or more first data components and one or more first data elements associated with this message are organized in a hierarchical structure. The hierarchical structure may correspond to any structure known in the art, such as a hierarchical tree structure. In particular, the hierarchical structure may represent a hierarchy (e.g., a class-based hierarchy) amongst the one or more first data components and the one or more first data elements associated with the message, as explained above.

Further, for this implementation, the hierarchical structure that corresponds to this specific first message may be composed of nodes. In particular, each node may correspond to a specific first data component or a specific first data element associated with the message. Accordingly, for this implementation, the associated party may (i.e., via its one or more computing systems) determine one or more paths associated with the specific first message by determining a path for each connected node (i.e., a specific first data component or a specific first data element) of this hierarchical structure. For such an implementation, each particular node of the hierarchical structure may correspond to a specific path, such that this specific path may be used to identify, locate, and/or access the particular node (i.e., a specific first data component or a specific first data element associated with the message).

The nodes of the hierarchical structure may include any node known in the art, such as one or more parent nodes, one or more child nodes, a root node, one or more leaf nodes, and/or the like. Furthermore, each node of the hierarchical structure may be connected to at least one other node. As is known in the art, a parent node may be connected to one or more child nodes, such that each child node may descend from a single parent node. In addition, a root node may correspond to a topmost node of the hierarchical structure and may not have a parent node, such that the other nodes of the hierarchical structure descend from this root node via direct connections (i.e., as a child node of the root node) or indirect connections (i.e., as a child node of one or more other nodes descending from the root node). Additionally, a leaf node may correspond to a node of the hierarchical structure that has no child node. For instance, the leaf node may correspond to a specific first data element of the hierarchical structure that corresponds to a representation of an atomic data type, such as a variable corresponding to a primitive data type (e.g., an integer data type), a simple type element expressed in XML syntax, and/or the like.

In one example, where the first messaging standard is the ISO 20022 standard, the “AuthorisationInitiationV02” message (i.e., a first message) may be associated with data components (i.e., first data components) and data elements (i.e., first data elements), as shown above in Tables 1 and 2. For this example, dictionary data relating to this message is assumed to be modified first dictionary data. In particular, as shown in Tables 1 and 2, the message definition data (i.e., first message definition data) and the dictionary data (i.e., modified first dictionary data) relating to the AuthorisationInitiationV02″ message may indicate that the data components and the data elements are organized in a class-based hierarchical structure. For this hierarchical structure corresponding to the message, the data components and the data elements may correspond to nodes of the structure.

For instance, as shown, the “AuthorisationInitiationV02” element (i.e., a first message definition) may correspond to a root node of the hierarchical structure. As is also shown, the “Body” element (i.e., a first data component) may be a child node of the “AuthorisationInitiationV02” element, such that the “AuthorisationInitiationV02” element may also be a parent node. Further, the “Envt” element (i.e., a first data element) may be a child node of the “Body” element, such that the “Body” element may also be a parent node. In addition, the “Card” element (i.e., a first data element) may be a child node of the “Envt” element, such that the “Envt” element may also be a parent node. Moreover, the “PAN” element (i.e., a first data element) may be a child node of the “Card” element, such that the “Card” element may also be a parent node. Furthermore, the “PAN” element may correspond to a simple type element, such that the “PAN” element may also correspond to a leaf node of the hierarchical structure. Additionally, the “Tx” element (i.e., a first data element) may be a child node of the “Body” element, such that the “Body” element may also be a parent node to this node. Further, the “TxTp” element (i.e., a first data element) may be a child node of the “Tx” element, such that the “Tx” element may also be a parent node. The “TxTp” element may correspond to a simple type element, such that the “TxTp” element may also correspond to a leaf node of the hierarchical structure.

Accordingly, for this example, to determine one or more paths for the data elements and the data components associated with the “AuthorisationInitiationV02” message, the associated party may use its one or more computing systems to determine one or more paths for, at least, the nodes mentioned above. In particular, the associated party may use its one or more computing systems to determine one or more paths for, at least, the following data components and data elements (i.e., the nodes) of the hierarchical structure: the “Hdr,” “Body,” and “SctyTrlr” elements (i.e., first data components) of the “AuthorisationInitiationV02” element; the “Envt,” “Tx,” and “AdddmData” elements (i.e., first data elements) of the “Body” element; the “TxTp” element (i.e., a first data element) of the “Tx” element; the “Card” element (i.e., a first data element) of the “Envt” element; and the “PAN” element (i.e., a first data element) of the “Card” element.

### 2. One or More Traversal Processes

In a further implementation, in order to determine the one or more paths for the nodes (i.e., the one or more first data components and the one or more first data elements) of the hierarchical structure corresponding to the specific first message, the associated party may (i.e., via its one or more computing systems) utilize one or more traversal processes on the hierarchical structure. In particular, the one or more traversal processes may be used to traverse (e.g., visit, select, and/or access) the nodes of the hierarchical structure. In addition, after traversing to a specific node of the hierarchical structure using the one or more traversal processes, the associated party may (i.e., via its one or more computing systems) utilize the one or more traversal processes to determine a path for that node. As explained above, this determined path may be used to identify, locate, and/or access the specific node (i.e., a specific data element or a specific data component associated with the message) of the hierarchical structure.

For such an implementation, the one or more traversal processes may be used on and/or applied to the first message definition data and the modified first dictionary data relating to the specific first message. As discussed above, the first message definition data and the modified first dictionary data relating to the message may indicate that the one or more first data components and the one or more first data elements associated with this message are organized as nodes in a hierarchical structure. Thus, by utilizing the one or more traversal processes on such data, the associated party may (i.e., via its one or more computing systems) use these one or more traversal processes to determine a path for each node of the hierarchical structure indicated in the data.

In some instances, and as mentioned above, the first message definition data and the modified first dictionary data may be included in one or more schemas (e.g., one or more dictionary schemas, one or more message schemas, and/or the like). For such instances, to determine a path for each of the nodes of the hierarchical structure, the one or more traversal processes may be utilized on these one or more schemas. Further, for instances in which at least one schema is an XML Schema document (e.g., the “cain.001.001.02” message schema discussed above), the one or more traversal processes may include one or more XPath traversal processes. In particular, an XPath traversal process may be configured to traverse (e.g., visit, select, and/or access) the nodes of an XML document. As is known in the art, an XML document (e.g., an XML Schema) may correspond to a hierarchical tree structure, such that components of the XML document may correspond to nodes of the structure. For an XML Schema, these nodes may correspond to XML elements (i.e., complex type elements and/or simple type elements). Moreover, for an XML schema (e.g., the “cain.001.001.02” message schema) that includes the first message definition data and/or the modified first dictionary data relating to the specific first message (e.g., the “AuthorisationInitiationV02” message), these XML elements (i.e., nodes) may correspond to the one or more first data components and/or the one or more first data elements associated with the message. Thus, for instances in which at least one schema associated with the specific first message is an XML Schema document, the one or more XPath traversal processes may be used on this schema in order to traverse these nodes (i.e., the one or more first data components and/or the one or more first data elements associated with the message) and, ultimately, determine paths for these nodes. As is known in the art, a path determined using an XPath traversal process may be referred to as an XPath.

The one or more traversal processes may utilize any techniques for traversing nodes of a hierarchical structure that are known in the art. In one instance, the one or more traversal processes may correspond to one or more recursive algorithms, where the one or more recursive algorithms may be configured to recursively traverse though the nodes of the hierarchical structure. In another instance, the one or more traversal processes may be configured to traverse the nodes of the hierarchical structure by stepping through, walking through, looping through, and/or traveling across the connections between the nodes until all of the nodes have been traversed. In yet another instance, the one or more traversal processes may be configured to traverse every node of the hierarchical structure by starting with the root node and then traversing through the connections between the nodes until reaching the one or more leaf nodes.

As noted above, after using the one or more traversal processes to traverse to a specific node of the hierarchical structure that corresponds to the first message, the associated party may (i.e., via its one or more computing systems) utilize the one or more traversal processes to determine a path for that specific node. In addition, each particular node of the hierarchical structure may correspond to a particular path. Thus, as explained above, a determined path for a specific node (i.e., a specific data element or a specific data component associated with the message) of the hierarchical structure may be used to identify, locate, and/or access the specific node. Further, the determined path for the specific node may be any type of path known in the art, such as a location path for the specific node. As described above, a location path for such a node may correspond to a sequence of location steps for use in identifying, locating, and/or accessing that node.

The one or more traversal processes may utilize any techniques known in the art to determine paths for nodes of a hierarchical structure. As noted above, each node of the hierarchical structure may be connected to at least one other node. In one instance, and as explained above, the one or more traversal processes may be configured to traverse every node of the hierarchical structure by starting with the root node and then traversing through the connections between the nodes until reaching the one or more leaf nodes. In such an instance, the one or more traversal processes may be configured to determine a path for each node that it traverses, where the path for a specific node may correspond to the connections between the specific node and the root node. Thus, for a hierarchical structure that corresponds to a particular first message, the one or more traversal processes may be configured to enumerate a path for each node (e.g., a first data component or a first data element) of the hierarchical structure.

In one example, the ISO 20022 standard (i.e., a first messaging standard) may be associated with message schemas for various electronic messages (i.e., first messages) of the standard, such as the “cain.001.001.02” message schema (i.e., a first message schema) for the “AuthorisationInitiationV02” message (i.e., a first message) shown above in Tables 1 and 2. As explained above, the “cain.001.001.02” message schema may include message definition data (i.e., first message definition data) and dictionary data (i.e., modified first dictionary data) relating to the AuthorisationInitiationV02″ message. In particular, as shown in Tables 1 and 2, the message definition data and the dictionary data relating to the “AuthorisationInitiationV02” message may indicate that data components (i.e., first data components) and data elements (i.e., first data elements) associated with the message are organized as nodes of a hierarchical structure.

In this example, the associated party may (i.e., via its one or more computing systems) use one or more XPath traversal processes (i.e., one or more traversal processes) on the “cain.001.001.02” message schema in order to traverse the nodes (i.e., the data components and the data elements) of the hierarchical structure and then determine paths for these nodes. For instance, as explained above, the “PAN” element (i.e., a first data element) associated with this message may correspond to a simple type element, such that the “PAN” element may also correspond to a leaf node of the hierarchical structure. Thus, the associated party may (i.e., via its one or more computing systems) use the one or more XPath traversal processes to, at least, traverse to this leaf node and then determine a path for the leaf node. In particular, the determined path for this leaf node may correspond to the connections between the leaf node and the root node (e.g., the “AuthorisationInitiationV02” element) of the hierarchical structure. For such an instance, the determined path may be a location path, where the location path may correspond to: “/Body/Envt/Card/PAN.” Specifically, this location path may correspond to a sequence of traversed nodes along the connections from the root node, where the nodes may be separated by slashes.

Thus, for this example, the associated party may (i.e., via its one or more computing systems) use the one or more XPath traversal processes to determine location paths for the nodes (i.e., the data components and the data elements) of the hierarchical structure that corresponds to the “AuthorisationInitiationV02” message. A portion of these determined location paths is shown below in Table 4.

TABLE 4

/Body/
/Body/AdddmData
/Body/AdddmData/AddtlAccptrData
/Body/AdddmData/AddtlAccptrData/AddtlId
/Body/AdddmData/AddtlAccptrData/AddtlId/OthrTp
/Body/AdddmData/AddtlAccptrData/AddtlId/Tp
. . .
/Body/Envt
/Body/Envt/Accptr
/Body/Envt/Accptr/AddtlCtctInf
/Body/Envt/Accptr/AddtlData
. . .
/Body/Envt/Card
/Body/Envt/Card/AddtlCardData
/Body/Envt/Card/CardCcyCd
/Body/Envt/Card/CardCtryCd
/Body/Envt/Card/CardPdctSubTp
/Body/Envt/Card/CardPdctTp
/Body/Envt/Card/CardPrtflIdr
/Body/Envt/Card/CardSeqNb
/Body/Envt/Card/FctvDt
/Body/Envt/Card/PAN
. . .
/Body/Tx
/Body/Tx/AcctBal
/Body/Tx/AcctBal/AcctTp
. . .
/Body/Tx/TxSubTp
/Body/Tx/TxTp
. . .
/Hdr/
/Hdr/BtchMgmtInf
/Hdr/BtchMgmtInf/BtchId
/Hdr/BtchMgmtInf/ColltnId
. . .
/SctyTrlr/
/SctyTrlr/MAC
/SctyTrlr/MACData
. . .

As shown in Table 4, the one or more XPath traversal processes may be configured to determine locations paths for various nodes (i.e., the data components and the data elements) of the hierarchical structure corresponding to the “AuthorisationInitiationV02” message. In particular, the location paths may be determined for, at least, the following data components and data elements (i.e., the nodes) of the hierarchical structure corresponding to this message: the “Hdr,” “Body,” and “SctyTrlr” elements (i.e., first data components) of the “AuthorisationInitiationV02” element (i.e., the first message definition); the “Envt,” “Tx,” and “AdddmData” elements (i.e., first data elements) of the “Body” element; the “TxTp” element (i.e., a first data element) of the “Tx” element; the “Card” element (i.e., a first data element) of the “Envt” element; and the “PAN” element (i.e., a first data element) of the “Card” element.

In a further implementation, when determining a path for a specific node of the hierarchical structure, the one or more traversal processes may be configured to generate path data for that node. In particular, the path data for the specific node may include data that corresponds to the determined path for the node. For example, as explained above with respect to Table 4, the associated party may (i.e., via its one or more computing systems) use the one or more XPath traversal processes to, at least, determine a location path for a leaf node, where the leaf node corresponds to the “PAN” element associated with the “AuthorisationInitiationV02” message. In particular, as discussed above, the location path for this leaf node may correspond to: “/Body/Envt/Card/PAN.” Thus, for this example, the one or more XPath traversal processes may generate path data for this leaf node, where the path data may correspond to the determined location path (i.e., “/Body/Envt/Card/PAN”) of the node. The generated path data may correspond to any data value known in the art, including a character value, a string value, and/or the like.

Additionally, the associated party may (i.e., via its one or more computing systems) utilize the one or more modeler tools mentioned above in order to determine the one or more paths associated with the one or more first messages as described above. For instance, the one or more modeler tools may be configured to utilize the one or more traversal processes on the hierarchical structure that corresponds to the specific first message. In particular, the one or more modeler tools may utilize the one or more traversal processes to traverse the nodes of the hierarchical structure and then determine the paths for these nodes.

Thus, in view of the above, after modifying first dictionary data that relates to the one or more first messages of the first messaging standard, the associated party of the system 200 may use its one or more computing systems to determine one or more paths associated with these one or more first messages. In particular, the associated party may (i.e., via its one or more computing systems) determine these one or more paths based on, at least, the modified first dictionary data, where the one or more paths may correspond to, at least, one or more first data elements associated with the messages. Specifically, these one or more paths may be used to, at least, identify, locate, and/or access these one or more first data elements associated with the messages.

### D. Generating a Path Schema

As discussed above, after modifying the first dictionary data relating to the one or more first messages of the first messaging standard, the associated party of the system 200 may (i.e., via its one or more computing systems) use the modified first dictionary data to identify, at least, the one or more first data elements that are associated with these one or more first messages. In particular, as described above, the associated party may (i.e., via its one or more computing systems) use the modified first dictionary data and the first message definition data to determine one or more paths for the one or more first data elements and the one or more first data components associated with the one or more first messages. As noted above, the one or more determined paths may be used to identify, locate, and/or access the one or more first data elements and the one or more data components associated with the messages. Specifically, as explained above, the associated party may (i.e., via its one or more computing systems) utilize the one or more traversal processes in order to determine these one or more paths.

Further, as described above, the one or more traversal processes may be configured to generate path data that corresponds to these one or more determined paths associated with the one or more first messages. In particular, as explained above, the one or more traversal processes may be configured to generate path data for a specific first data element or a specific first data component associated with the messages, where the generated path data may correspond to a determined path for the specific first data element or the specific first data component. Additionally, the generated path data may correspond to any data value known in the art, including a character value, a string value, and/or the like.

In some implementations, the associated party of the system 200 may (i.e., via its one or more computing systems) generate a path schema for the one or more first messages based on the generated path data, where the generated path data corresponds to the one or more determined paths associated with the messages. As explained below, the path schema may be used to validate one or more mapping rules associated with the one or more first messages. In particular, the path schema may be configured to restrict which of the one or more first data elements and the one or more first data components may be used for these mapping rules.

The path schema may correspond to any type of schema document known in the art, and data included in the path schema may be in a machine-readable format. Further, the data included in the path schema may be expressed using any syntax and/or file format known to those skilled in the art, including XML, JSON, and/or the like. In one instance, as is known in the art, the path schema may be an XML Schema document, where the data included in the path schema may be expressed using XML. For such an instance, the path schema may have “.xsd” as a filename extension.

In one such implementation, the associated party may (i.e., via its one or more computing systems) generate a path schema for the one or more first messages based on the generated path data, where the path schema may utilize a path data element. In particular, the path schema may include data that corresponds to this path data element, where the path data element may relate to the one or more determined paths associated with the one or more first messages. The path data element may be any type of data element known in the art. Further, the path data element may correspond to any data type known in the art, such that the path data element may be associated with any data value known in the art. For instance, the path data element may be associated with one or more character values, one or more string values, and/or the like.

In this implementation, the path schema may be configured to restrict the path data element to a set of data values based on the generated path data from the one or more traversal processes. As mentioned above, the generated path data may correspond to the one or more determined paths associated with the one or more first messages. Thus, the path schema may be configured to restrict the path data element to a set of data values that correspond to these one or more determined paths of the generated path data. As explained above, these one or more determined paths of the generated path data correspond to the one or more determined paths for the one or more first data elements and the one or more first data components associated with the one or more first messages.

For instance, the generated path data may include data that corresponds to the determined paths associated with the one or more first messages, where the generated path data may correspond to one or more character values and/or one or more string values for these determined paths. Further, the path data element of the path schema may also be associated with one or more character values and/or one or more string values. For this instance, the path schema may be configured to restrict its path data element to the data values (i.e., one or more character values and/or one or more string values) of the determined paths of the generated path data. In a further instance, where the path schema is an XML Schema document that includes data expressed using XML, the path data element may be a simple type XML element associated with one or more character values and/or one or more string values. For this instance, the path schema may be configured to restrict the path data element by using one or more enumeration constraints, such that the path data element may be restricted to a set of data values enumerated in the path schema. In particular, these enumerated data values may correspond to the data values (i.e., one or more character values and/or one or more string values) of the determined paths of the generated path data.

In one example, and as similarly explained above for Table 4, the ISO 20022 standard (i.e., a first messaging standard) may be associated with message schemas for various electronic messages (i.e., first messages) of the standard, such as the “cain.001.001.02” message schema (i.e., a first message schema) for the “AuthorisationInitiationV02” message (i.e., a first message) shown above in Tables 1 and 2. As explained above, the “cain.001.001.02” message schema may include message definition data (i.e., first message definition data) and dictionary data (i.e., modified first dictionary data) relating to the AuthorisationInitiationV02″ message. In particular, as shown in Tables 1 and 2, the message definition data and the dictionary data relating to the “AuthorisationInitiationV02” message may indicate that data components (i.e., first data components) and data elements (i.e., first data elements) associated with the message are organized as nodes of a hierarchical structure.

In this example, the associated party of the system 200 may (i.e., via its one or more computing systems) use one or more XPath traversal processes (i.e., one or more traversal processes) on the “cain.001.001.02” message schema in order to traverse the nodes (i.e., the data components and the data elements) associated with the “AuthorisationInitiationV02” message and then determine paths (e.g., location paths) for these nodes associated with the message, where a portion of the determined paths are shown in Table 4. In particular, the one or more XPath traversal processes may generate path data that corresponds to these determined paths, where the generated path data may correspond to one or more string values for the determined paths.

Further, in this example, the associated party may use its one or more computing systems to generate a path schema for, at least, the “AuthorisationInitiationV02” message based on the generated path data. The path schema may be an XML Schema document, where the data included in the path schema may be expressed using XML. In addition, the path schema may include data that corresponds to a simple type element (i.e., a path data element). In particular, the path schema may include data that restricts this simple type element based on the generated path data of Table 4. Specifically, the simple type element may be restricted to the one or more string values for the determined paths corresponding to the generated path data. Such a path schema and a portion of its associated data is shown below in Table 5.

```
TABLE 5
<?xml version=“1.0”?>
<xs:schema xmlns:xs=“http://www.w3.org/2001/XMLSchema”>
<xs:simpleType name=“PathElementAtica”>
  <xs:restriction base=“xs:string”>
    <xs:enumeration value=“Body.AdddmData”/>
    <xs:enumeration value=“Body.AdddmData.AddtlAccptrData”/>
    <xs:enumeration value=“Body.AdddmData.AddtlAccptrData.AddtlId”/>
    <xs:enumeration value=“Body.AdddmData.AddtlAccptrData.AddtlId.OthrTp”/>
    <xs:enumeration value=“Body.AdddmData.AddtlAccptrData.AddtlId.Tp”/>
    . . .
    <xs:enumeration value=“Body.Envt”/>
    <xs:enumeration value=“Body.Envt.Accptr”/>
    <xs:enumeration value=“Body.Envt.Accptr.AddtlCtctInf”/>
    <xs:enumeration value=“Body.Envt.Accptr.AddtlData”/>
    . . .
    <xs:enumeration value=“Body.Envt.Card”/>
    <xs:enumeration value=“Body.Envt.Card.AddtlCardData”/>
    <xs:enumeration value=“Body.Envt.Card.CardCcyCd”/>
    <xs:enumeration value=“Body.Envt.Card.CardCtryCd”/>
    <xs:enumeration value=“Body.Envt.Card.CardPdctSubTp”/>
    <xs:enumeration value=“Body.Envt.Card.CardPdctTp”/>
    <xs:enumeration value=“Body.Envt.Card.CardPrtflIdr”/>
<xs:enumeration value=“Body.Envt.Card.CardSeqNb”/>
    <xs:enumeration value=“Body.Envt.Card.FctvDt”/>
    <xs:enumeration value=“Body.Envt.Card.PAN”/>
    . . .
    <xs:enumeration value=“Body.Tx”/>
    <xs:enumeration value=“Body.Tx.AcctBal”/>
    <xs:enumeration value=“Body.Tx.AcctBal.AcctTp”/>
    . . .
    <xs:enumeration value=“Body.Tx.TxSubTp”/>
    <xs:enumeration value=“Body.Tx.TxTp”/>
    . . .
    <xs:enumeration value=“Hdr”/>
    <xs:enumeration value=“Hdr.BtchMgmtInf”/>
    <xs:enumeration value=“Hdr.BtchMgmtInf.BtchId”/>
    <xs:enumeration value=“Hdr.BtchMgmtInf.ColltnId”/>
    . . .
    <xs:enumeration value=“SctyTrlr”/>
    <xs:enumeration value=“SctyTrlr.MAC”/>
    <xs:enumeration value=“SctyTrlr.MACData”/>
    . . .
  </xs:restriction>
</xs:simpleType>
. . .
  <xs:complexType name=“CisMappingElement”>
    <xs:sequence>
      <xs:element name=“name” type=“AticaElement”/>
      <xs:element name=“cisIndex” type=“CisElement”/>
    </xs:sequence>
  </xs:complexType>
  <xs:simpleType name=“AticaElement”>
    <xs:restriction base=“PathElementAtica”>
    </xs:restriction>
  </xs:simpleType>
  <xs:simpleType name=“CisElement”>
    <xs:restriction base=“PathElementCis”>
    </xs:restriction>
  </xs:simpleType>
  <xs:element name=“CisElementMappings”>
  <xs:complexType>
    <xs:sequence>
    <xs:element name=“Mapping” type=“CisMappingElement” maxOccurs=“unbounded”/>
    </xs:sequence>
  </xs:complexType>
  </xs:element>
</xs:schema>
```

As shown in Table 5, the path schema may include data that corresponds to a simple type element named “PathElementAtica” (i.e., a path data element). The “PathElementAtica” element may be restricted to one or more string values, such as, at least, the enumerated values shown in Table 5. In particular, the enumerated values of the “PathElementAtica” element may be correspond to the one or more string values for the determined paths corresponding to the generated path data. Specifically, each enumerated value may correspond to a string value for a dot-notation format of these determined paths. Additionally, as shown in Table 5, the path schema may also include data that may facilitate a recording of mapping rules data associated with, at least, the “AuthorisationInitiationV02” message, such as for mapping rules data that may involve the one or more first data elements and the one or more first data components associated with the message. Such data may correspond to the following elements shown in Table 5: the complex type element named “CisMappingElement,” the complex type element named “AticaElement,” the complex type element named “CisElement,” and the complex type element named “CisElementMappings.”

In a further implementation, the associated party may (i.e., via its one or more computing systems) utilize the one or more modeler tools mentioned above in order to generate a path schema for the one or more first messages based on the generated path data, as described above. In particular, the one or more modeler tools may be configured to generate the path schema such that the path schema may be used to validate one or more mapping rules associated with the one or more first messages, as described herein. Specifically, the one or more modeler tools may be configured to generate the path schema for the one or more first messages based on the generated path data, where the path schema may utilize a path data element.

Thus, in view of the above, after using the modified first dictionary data and the first message definition data to determine one or more paths associated with the one or more first messages, the associated party may (i.e., via its one or more computing systems) generate a path schema for the one or more first messages based on the generated path data, where the generated path data corresponds to the one or more determined paths associated with the messages. In particular, the path schema may be configured to restrict which of the one or more first data elements and the one or more first data components may be used for these mapping rules. For instance, the path schema may be configured to restrict the path data element to a set of data values based on the one or more determined paths associated with the generated path data.

### E. Recording Mapping Rules Data

As discussed above, the associated party of the system 200 may use its one or more computing systems to modify the first dictionary data relating to the one or more first messages of the first messaging standard. In particular, the associated party may (i.e., via its one or more computing systems) modify the first dictionary data in order to modify (e.g., add, remove, and/or change) the one or more first data elements associated with the one or more first messages. As explained above, by modifying these one or more data elements, one or more mapping rules may no longer be valid for the electronic messages of the first and second messaging standards. Thus, in view of the modified first dictionary data, the associated party may (i.e., via its one or more computing systems) need to record mapping rules data for the one or more first messages and the one or more second messages of these messaging standards.

In some implementations, in view of the modified first dictionary data, the associated party of the system 200 may use its one or more computing systems to record the mapping rules data for the first messaging standard and the second messaging standard based on the modified first dictionary data, where recording the mapping rules data may include validating the one or more mapping rules of the mapping rules data based on the path schema. As noted above, the mapping rules data may be recorded in a mapping document (e.g., a specifications, a schemas, a file, and/or the like). The mapping document may be any type of document known in the art. For instance, the mapping document may be an XML document, such that the mapping rules data recorded therein may be expressed using XML syntax.

In one such implementation, in view of the modified first dictionary data, the associated party may record (i.e., via its one or more computing systems) mapping rules data for a particular mapping rule in a mapping document for the first and second messaging standards. As described above, the particular mapping rule may be configured to map a specific first data element associated with a specific first message to a specific second data element associated with a specific second message, where the data elements may be equivalent to one another (e.g., each represent an equivalent data value relating to the business transaction). In this implementation, while the associated party records (i.e., via its one or more computing systems) the mapping rules data for this particular mapping rule, the one or more computing systems may be configured to validate the mapping rules data based on the path schema.

In particular, for this implementation, the one or more computing systems may be configured to validate the mapping rules data by determining whether the data is in compliance with the path schema. Specifically, for the particular mapping rule, the one or more computing systems may determine whether a data value associated with the specific first data element is included amongst the restricted set of data values for the path data element in the path schema. In one instance, where the path schema is an XML Schema document, the one or more computing systems may determine whether the data value associated with the specific first data element is included amongst the enumerated data values for the path data element. The data value (e.g., one or more character values, one or more string values, and/or the like) associated with the specific first data element may correspond to a path (e.g., a location path) for the data element. Additionally, as noted above, the restricted set of data values (e.g., one or more character values, one or more string values, and/or the like) for the path data element may correspond to the one or more paths determined based on, at least, the modified first dictionary data. As is explained above, these paths correspond to the one or more first data elements and the one or more first data components associated with the one or more first messages.

In a further implementation, to determine whether the data value associated with the specific first data element of the particular mapping rule is included amongst the restricted set of data values for the path data element, the one or more computing systems may compare the data value associated with the specific first data element to each of the restricted data values for the path data element. Based on this comparison, the one or more computing systems may determine whether to validate the mapping rules data for this particular mapping rule. In one instance, based on the comparison, the one or more computing systems may determine that the data value associated with the specific first data element is included amongst the restricted set of data values for the path data element in the path schema. In such an instance, the one or more computing systems may determine that the mapping rules data associated with this particular mapping rule is valid, thereby allowing the associated party (i.e., via its one or more computing systems) to record the mapping rules data.

In another instance, based on the comparison, the one or more computing systems may determine that the data value associated with the specific first data element is not included amongst the restricted set of data values for the path data element. Thus, in such an instance, the one or more computing systems may determine that the mapping rules data associated with this particular mapping rule is not valid. For such an instance, the one or more computing systems may generate one or more notifications for the associated user, where the one or more notifications may indicate that the mapping rules data for this particular mapping rule is not valid. In particular, the one or more notifications may indicate that the specific first data element being used in the particular mapping rule is incorrect and/or not valid. Further, the one or more computing systems may be configured to display the one or more notifications to the associated user (e.g., via a presentation unit of a computing system). The one or more notifications may include any notification known in the art, such as an underlining effect and/or a highlighting effect on displayed text that correspond to the mapping rules data. For example, when the associated party (i.e., via its one or more computing systems) records the mapping rules data by entering text that corresponds to the particular mapping rule, the one or more computing systems may underline and/or highlight the text associated with the specific first data element to indicate that this specific first data element is not valid.

For example, the associated party of system 200 may use its one or more computing systems to record mapping rules data for the “AuthorisationInitiationV02” message (i.e., a first message) of the ISO 20022 standard (i.e., a first messaging standard) and an electronic message (i.e., a second message) of the ISO 8353 standard (i.e., a second messaging standard). As shown below in Table 6, the mapping rules data for these messages may be recorded in a mapping document (i.e., an XML document), such that the mapping rules data recorded therein may be expressed using XML syntax. In particular, the mapping rules data recorded in the mapping document may include data for, at least, a first mapping rule and a second mapping rule for these messages. A portion of the mapping document and the mapping rules data recorded therein is shown below in Table 6.

```
TABLE 6
<?xml version=“1.0” encoding=“UTF-8”?>
<CisElementMappings xmlns:xsi=“http://www.w3.org/2001/XMLSchema-instance”
xsi:noNamespaceSchemaLocation=“mappingschema.xsd”>
  <Mapping>
    <name>Body.Envt.Card.PAN</name>
    <cisIndex>DE2</cisIndex>
  <Mapping>
    <name>Body.Tx.TxTp</name>
    <cisIndex>DE3.1.00</cisIndex>
. . .
</CisElementMappings>
```

As shown in Table 6, while the associated party records (i.e., via its one or more computing systems) the mapping rules data for the first and second mapping rules, the one or more computing systems may be configured to validate the mapping rules data based on a path schema named “mappingschema.xsd.” The path schema named “mappingschema.xsd” may correspond to the path schema shown in Table 5.

As shown, the first mapping rule may be configured to map the “PAN” element (i.e., a specific first data element) associated with the “AuthorisationInitiationV02” message to the “DE2” data element (i.e., a specific second data element) associated with the electronic message of the ISO 8353 standard. In particular, to map the “PAN” element, the mapping rules data for the first mapping rule may include a data value (e.g., a string value) that corresponds to a location path for the “PAN” element. Thus, while the associated party records (i.e., via its one or more computing systems) the mapping rules data for the first mapping rule (e.g., by entering text that corresponds to the particular mapping rule), the one or more computing systems may determine whether this data value is included amongst the enumerated data values for the path data element, as shown in Table 5. Based on comparisons of the data value for the “PAN” element and the enumerated values of Table 5, the one or more computing systems may determine that the data value for the “PAN” element is included amongst the enumerated values. Thus, the one or more computing systems may determine that the mapping rules data associated with first mapping rule (i.e., and the “PAN” element) is valid. Similarly, as shown, the second mapping rule may be configured to map the “TxTp” element (i.e., a specific first data element) associated with the “AuthorisationInitiationV02” message to the “DE3.1.00” data element associated with the electronic message of the ISO 8353 standard. While the associated party records (i.e., via its one or more computing systems) the mapping rules data for the second mapping rule, the one or more computing systems may similarly determine that this mapping rules data (i.e., and the “TxTp” element) is valid based on the path schema.

In further implementations, the associated party may (i.e., via its one or more computing systems) utilize the one or more modeler tools mentioned above in order to record the mapping rules data for the first messaging standard and the second messaging standard based on the modified first dictionary data, including by validating the one or more mapping rules of the mapping rules data based on the path schema. In particular, the one or more modeler tools may be used to record the mapping rules data in a mapping document, such that the one or more modeler tools may be configured to validate the mapping rules data by determining whether the data is in compliance with the path schema, as described above. A modeler tool that is configured to determine whether the mapping rules data complies with the path schema in such a manner may be referred to as a schema-compliant modeler tool. Furthermore, the associated party may (i.e., via its one or more computing systems) utilize other features of the one or more modeler tools when recording the mapping rules data. For instance, when the associated party (i.e., via its one or more computing systems) records the mapping rules data via the one or more modeler tools by entering text that corresponds to a particular mapping rule, the one or more modeler tools may perform an autocompletion of the text based on the path schema, such as text associated with the specific first data element being used in the rule.

Thus, by validating the one or more mapping rules of the mapping rules data based on the path schema as described above, the associated party may be able to (i.e., via its one or more computing systems) avoid committing one or more errors when recording the recording the mapping rules data. As noted above, such errors may include one or more typographical errors, one or more syntax errors, one or more formatting errors, and/or the like. Specifically, the associated party may be able to ensure that the first data elements being mapped in the mapping rules data is in compliance with the one or more paths (e.g., the one or more first data elements) that were determined based on, at least, the modified first dictionary data. Similarly, in other implementations, the associated party may (i.e., via its one or more computing systems) also validate the one or more mapping rules of the mapping rules data based on a schema for the one or more second data elements associated with one or more second messages of the second messaging standard.

Accordingly, in view of the implementations discussed above with respect to FIGS. 1 and 2, a system and method for validating a mapping rule for messaging standards are described herein. In certain implementations, computing systems 221A-E are configured to generate a path schema based on hierarchical paths determined via one or more traversal processes, such as an XPath traversal process. This path schema explicitly defines allowable data element structures and permissible value constraints. In addition, the computing systems may further programmatically generate enumerated schemas to clearly restrict data entry to valid, schema-defined values. These enumerated schemas can then be utilized within schema-compliant modeler tools to provide immediate real-time validation and error detection, significantly improving mapping accuracy and reducing manual translation errors.

In certain implementations, after performing the one or more traversal processes (e.g. an XPath traversal process) through, at least, the modified dictionary data, the system may be used to programmatically generates an enumerated schema (e.g., such as an XML Schema Definition (.xsd) file). This enumerated schema explicitly lists permissible hierarchical paths and data elements as restricted enumerations. By defining data elements explicitly within the enumerated schema, the invention enables automatic enforcement of schema compliance. This automated enumeration significantly reduces manual errors such as typographical mistakes by limiting data entries to predefined valid values within schema-compliant editors.

Specifically, by defining data elements explicitly within the enumerated schema (e.g., a path schema), the invention enables automatic enforcement of schema compliance with respect to mapping rules data. This automated enumeration significantly reduces manual errors with respect to one or more mapping rules of the mapping rules data, such as typographical mistakes by limiting data entries to predefined valid values within schema-compliant modeler tools. Advantageously, the generated enumerated schema can be utilized directly within commercially available schema-compliant modeler tools (e.g., Eclipse, Oxygen XML Editor, or IntelliJ). These modeler tools enforce compliance by immediately highlighting invalid data entries or typos in real-time (e.g., with visual indicators such as red “squiggly” lines), particularly based on a comparison of the such data entries of a mapping rule with the determined paths of the path schema. This immediate feedback significantly enhances the reliability and accuracy of mapping translations by instantly notifying the modeler of errors at the moment of data entry, rather than after extensive downstream processing.

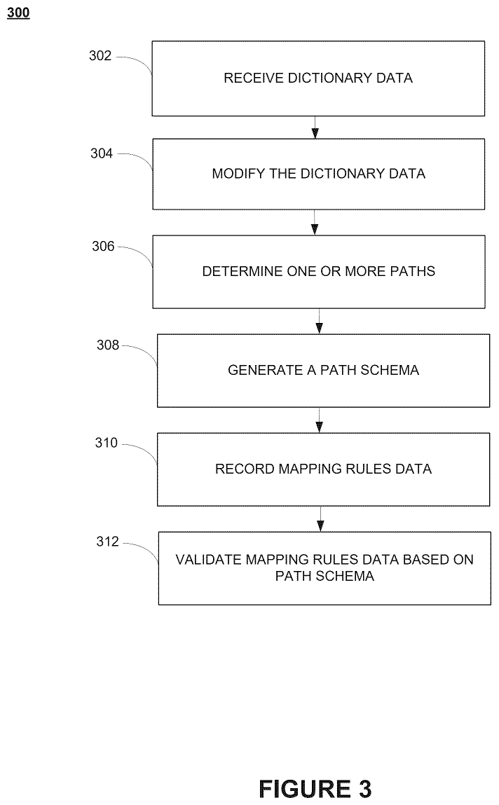

FIG. 3 is a flow diagram illustrating an exemplary method 300 for recording and validating mapping rules between messages of different messaging standards in accordance with implementations of various techniques described herein. The method 300 may be implemented by a processing device or computing system configured to handle messaging standards, such as ISO 20022 and ISO 8583, or similar standards. Advantageously, the method 300 provides automated, precise, and schema-compliant validation of mapping rules, significantly reducing manual errors, enhancing message translation reliability, and ensuring robust interoperability between distinct financial messaging standards.

Initially, at block 302, the method 300 includes receiving dictionary data associated with one or more first messages of a first messaging standard. The dictionary data defines hierarchical structures of data elements, which are utilized for interpreting and translating message contents. Dictionary data typically includes definitions for data elements and components, organized hierarchically as nodes, facilitating clear identification and handling of message components.

At block 304, the received dictionary data is modified, which may involve updating existing data elements, adding new data elements, or removing obsolete data elements based on evolving standards or message format changes. For example, modifications could include adjusting data element formats to accommodate new message types or updating hierarchical relationships between elements.

At block 306, the method determines one or more hierarchical paths for each data element associated with the modified dictionary data. Determining these paths involves executing a traversal process, such as an XPath traversal process, through the hierarchical structure defined by, at least, the modified dictionary data. Each path uniquely corresponds to a specific data element, enabling precise identification of valid hierarchical locations of data elements within message structures.

In class-based hierarchical structures, such as those present in ISO 20022 (ATICA) messages, a particular data class (e.g., Partyldentification197) may appear multiple times in different hierarchical locations within a message definition. Simply identifying a data element by class name is insufficient. Accordingly, precise XPath traversal techniques are employed to unequivocally specify hierarchical paths from a root node to the precise instance of each data element within the class hierarchy. This ensures absolute clarity in mappings and prevents ambiguities during translation processes.

Continuing at block 308, a path schema is generated based on the determined paths. The path schema includes path data elements that represent allowable hierarchical paths derived from the modified dictionary data. Importantly, for example, the path schema restricts permissible values or structures for each data element, ensuring that message translations or mappings adhere strictly to predefined standards and specifications. For instance, permissible values for a transaction type field may be explicitly limited based on defined business rules. In various aspects, generating the path schema typically involves a user invoking a schema generation tool (e.g., by interacting with a graphical interface element), which programmatically generates the schema based on the modified dictionary data.

Subsequently, at block 310, mapping rules data is recorded based on the modified dictionary data. The mapping rules data includes schema-compliant mappings defined or confirmed by a user, utilizing the previously generated path schema. These mapping rules explicitly define relationships and transformations required for accurate and interoperable message translations. Hence, in certain aspects, rather than automatically recording the mapping rules, inventive schemes and techniques enable the user to define and record valid mappings explicitly, assured by compliance with the path schema constraints. Accordingly, the mapping rules data provides structured instructions for translating messages from the first messaging standard into corresponding second messages of a second messaging standard.

At block 312, the recorded mapping rules undergo validation using the path schema. Specifically, this validation step includes comparing each mapping rule against corresponding permissible values and hierarchical structures defined by the path schema. Validation may utilize a modeler tool configured to ensure compliance with schema constraints. Mapping rules adhering to these schema restrictions are confirmed as valid, ensuring robust compliance with the second messaging standard. This validation step includes verifying the structural correctness and allowable values within mapping rules, thereby preventing translation errors and inconsistencies.

Advantageously, the result of method 300, facilitated through these sequential steps, is a robust, validated set of mapping rules that can reliably be employed for message standard conversions in financial transaction processing systems. This significantly reduces translation errors and enhances interoperability across different financial messaging platforms, facilitating efficient and accurate transaction processing.

In other implementations, the associated party of the system 200 may (i.e., via its one or more computing systems) utilize the one or more determined paths associated with the one or more first messages for other purposes, such as to generate and/or maintain documentation relating to the one or more first messages. In particular, the documentation may include explanatory text that explains and/or defines the one or more first messages, such as by explaining and/or defining the one or more first data components and the one or more first data elements associated with the messages.

Such documentation may correspond to various first messages of the first messaging standard, including a specific subset of the first messages. As noted above, a subset of first messages of a first messaging standard (e.g., ISO 20022) may include first messages that correspond to a business domain (e.g., the Cards Domain), a message set (e.g., the ATICA message set), a business area (e.g., the CAIN business area of the ATICA message set), and/or the like. For instance, where the documentation corresponds to a subset that includes the CAIN business area of the ATICA message set described above, such documentation may include explanatory text relating to the first messages (e.g., the “AuthorisationInitiationV02” message) of this subset. In particular, this explanatory text may correspond to the first message definition data and the modified first dictionary data relating to these messages, such that the explanatory text may explain and/or define the first data components and the first data elements associated with the messages.

In such implementations, the associated party may (i.e., via its one or more computing systems) index the documentation relating to the one or more first messages based on the one or more first data components and the one or more first data elements associated with the messages. For instance, the documentation may be indexed based on the hierarchy (e.g., a class-based hierarchy) amongst the one or more first data components and the one or more first data elements associated with the messages, as explained above. In particular, within the documentation, a specific first data component or a specific first data element may be indexed to a portion of the explanatory text pertaining to that specific first data component or that specific first data element. For such implementations, the indexed first data components and the indexed first data elements may correspond to the one or more determined paths described above. In a further implementation, the associated party may (i.e., via its one or more computing systems) validate the indexed first data components and the indexed first data elements based on the one or more determined paths. Such a validation may ensure that the indexed first data components and the indexed first data elements are accurate. In one example, to perform such a validation, the associated party may (i.e., via its one or more computing systems) compare the above-described generated path data to data values (e.g., characters values, string values, etc.) associated with the indexed first data components and the indexed first data elements. In another example, to perform such a validation, the associated party may (i.e., via its one or more computing systems) compare the restricted set of data values for the path data element of the path schema to data values (e.g., characters values, string values, etc.) associated with the indexed first data components and the indexed first data elements.

### IV. Computing System

FIG. 4 illustrates a diagram of a computing system 400 in which one or more various technologies described herein may be incorporated and practiced. The computing system 400 may be any computing system known to those skilled in the art. For example, the computing system 400 may include one or more servers, workstations, personal computers, laptops, tablets, smartphones, personal digital assistants (PDAs), and/or the like. In one implementation, the computing system 400 may include a single computing system. In another implementation, the computing system 400 may include multiple computing systems located in close proximity and/or distributed over a geographic region, where the computing systems may be configured to function as described herein.

The computing system 400 can be used to implement any of the computing systems discussed above, such as the one or more computing systems 221A, 221B, 221C, 221D, and 221E. Those skilled in the art will understand that the system 200 may use different computing systems and/or arrangements of computing systems than those described with respect to FIG. 4. In addition, different components and/or arrangements of components may be used in other computing systems.

Referring to FIG. 4, the computing system 400 may include a processor 402 and a memory 404 coupled to and/or in communication with the processor 402. The processor 402 may include one or more processing units (e.g., in a multi-core configuration and/or the like). For example, the processor 402 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 404, as described herein, may include one or more devices that permit data, instructions, etc., to be stored therein and retrieved therefrom. The memory 404 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 404 may be configured to store, without limitation, images, private and/or public keys, public/private key pairs, identity records, certified and/or certification records, hashed data, signed data, one or more data structures, and/or other types of data suitable for use as described herein. Furthermore, in various implementations, computer-executable instructions may be stored in the memory 404 for execution by the processor 402 to cause the processor 402 to perform one or more of the functions described herein, such that the memory 404 may be a physical, tangible, and non-transitory computer readable storage media. Such instructions may be used to improve the efficiencies and/or performance of the processor 402 and/or other computer system components configured to perform one or more of the various operations herein. It should be appreciated that the memory 404 may include a variety of different memories, each implemented in one or more of the functions or processes described herein.

The computing system 400 may also include a presentation unit 406 that is coupled to and/or in communication with the processor 402. However, it should be appreciated that the computing system 400 could include output devices other than the presentation unit 406 and/or the like. The presentation unit 406 may output information to a user, such as by using a visual output. Further, one or more interfaces may be displayed at computing system 400, including at presentation unit 406, to display certain information. The one or more interfaces may be defined by the one or more applications mentioned above, defined by websites, defined by mobile applications, and/or the like. In addition, the one or more interfaces may be used to capture images of documents, capture selfies, capture biometrics, and/or the like. The presentation unit 406 may include, without limitation, a liquid crystal display (LCD), a light-emitting diode (LED) display, an organic LED (OLED) display, an “electronic ink” display, speakers, and/or the like. In some implementations, the presentation unit 406 may include multiple devices.

In addition, the computing system 400 may include an input device 408 configured to receive and/or acquire one or more inputs from a user (i.e., user inputs), such as in response to prompts from the one or more applications described above. The one or more inputs may include images of documents, images of a user (e.g., biometric data), and/or the like. The input device 408 may include a single input device or multiple input devices. The input device 408 may be coupled to and/or in communication with the processor 402. The input device 408 may include, for example, a keyboard, a pointing device, a mouse, a stylus, a camera, fingerprint scanner, a touch sensitive panel (e.g., a touch pad, a touch screen, and/or the like), acquisition equipment as described above, another computing system, an audio input device, or combinations thereof. In one implementation, a touch screen, such as that included in a tablet, a smartphone, or similar device, may behave as both a presentation unit and an input device. As mentioned above, the computing system may include and/or configured to be coupled to any equipment used to acquire one or more images of documents and/or biometric data. Such equipment may include a camera, a biometric sensor (e.g., fingerprint sensor, iris scanner, palm scanner, and/or the like), and/or any other device configured to acquire such data.

Further, the illustrated computing system 400 may include a network interface 410 coupled to and/or in communication with the processor 402 and the memory 404. The network interface 410 may include, without limitation, a wired network adapter, a wireless network adapter (e.g., a near field communication (NFC) adapter, a Bluetooth adapter, and/or the like), a mobile network adapter, and/or other devices capable of communicating to one or more different devices of the networks described herein. Further, in some implementations, the computing system 400 may include the processor 402 and one or more network interfaces incorporated into or with the processor 402. In some implementations, the computing system 400 may include global positioning system (GPS) capability, whereby the computing system 400 may determine its current geographic location, perform mapping applications, and/or the like.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving dictionary data associated with a first messaging standard, wherein the dictionary data defines hierarchical relationships among a plurality of data elements used by one or more messages of the first messaging standard;
modifying the dictionary data based on the first messaging standard;
determining, based on the modified dictionary data, one or more hierarchical paths corresponding to respective data elements, wherein determining the one or more hierarchical paths comprises performing a traversal of the modified dictionary data;
generating, based on the determined hierarchical paths, a path schema comprising path data elements that define hierarchical locations and permissible values for the plurality of data elements, wherein the path schema comprises enumerated values corresponding to the determined hierarchical paths; and
recording mapping rules data configured to translate between the first messaging standard and a second messaging standard, wherein recording the mapping rules data comprises validating each mapping rule based on the path schema by determining whether a path value identified in the respective mapping rule conforms to the enumerated values of the path schema.

2. The method of claim 1, further comprising:
receiving message definition data corresponding to definitions of the one or more messages of the first messaging standard, wherein the definitions comprise one or more data components associated with the plurality of data elements;
validating indexed documentation associated with the one or more messages based on the one or more determined hierarchical paths; or
combinations thereof.

3. The method of claim 2, wherein the dictionary data defines associations between the one or more data components and the plurality of data elements.

4. The method of claim 1, wherein the dictionary data organizes the plurality of data elements and associated one or more data components as nodes within a hierarchical data structure.

5. The method of claim 1, wherein validating each mapping rule comprises:
utilizing a schema-compliant editing tool configured to automatically enforce compliance with the path schema.

6. The method of claim 1, wherein performing the traversal of the modified dictionary data comprises comprises executing an XPath traversal algorithm.

7. The method of claim 1, wherein validating each mapping rule comprises:
comparing a respective mapping rule with corresponding path schema constraints; and
confirming validity of the respective mapping rule based on conformity to the path schema constraints.

8. A system, comprising:
one or more processors; and
at least one memory comprising instructions executable by the one or more processors to cause the system to:
receive dictionary data defining hierarchical relationships among a plurality of data elements associated with messages of a first messaging standard;
modify the dictionary data based on the first messaging standard;
determine, through traversal of the modified dictionary data, one or more hierarchical paths associated with respective data elements;
generate a path schema based on the determined hierarchical paths, the path schema constraining locations and permissible values for the data elements, wherein the path schema comprises enumerated values corresponding to the determined hierarchical paths; and
record and validate mapping rules data configured to translate between the first messaging standard and a second messaging standard, wherein validating the mapping rules data comprises comparing the mapping rules data against the path schema constraints by determining whether a path value identified in a respective mapping rule of the mapping rules data conforms to the enumerated values of the path schema.

9. The system of claim 8, wherein the instructions further cause the system to:
receive message definition data comprising message definitions with one or more data components related to the plurality of data elements;
validate indexed documentation associated with the one or more messages based on the one or more determined hierarchical paths; or
combinations thereof.

10. The system of claim 9, wherein the dictionary data defines associations between the one or more data components and the plurality of data elements.

11. The system of claim 8, wherein the dictionary data organizes the plurality of data elements and associated one or more data components as nodes within a hierarchical data structure.

12. The system of claim 8, wherein validating each mapping rule comprises:
utilizing a schema-compliant editing tool configured to automatically enforce compliance with the path schema.

13. The system of claim 8, wherein determining hierarchical paths comprises performing XPath traversal algorithms on the modified dictionary data.

14. The system of claim 8, wherein validating each mapping rule comprises:
comparing a respective mapping rule with corresponding path schema constraints; and
confirming validity of the respective mapping rule based on conformity to the path schema constraints.

15. A non-transitory computer-readable medium storing instructions that, when executed by a computer system, cause the computer system to:
receive dictionary data defining hierarchical relationships among a plurality of data elements associated with messages of a first messaging standard;
modify the dictionary data based on the first messaging standard;
determine, through traversal of the modified dictionary data, one or more hierarchical paths associated with respective data elements;
generate a path schema based on the determined hierarchical paths, the path schema constraining locations and permissible values for the data elements, wherein the path schema comprises enumerated values corresponding to the determined hierarchical paths; and
record and validate mapping rules data configured to translate between the first messaging standard and a second messaging standard, wherein validating the mapping rules data comprises comparing the mapping rules data against the path schema constraints by determining whether a path value identified in a respective mapping rule of the mapping rules data conforms to the enumerated values of the path schema.

16. The non-transitory computer-readable medium of claim 15, wherein the instructions further cause the computer system to:
receive message definition data comprising definitions with one or more data components related to the plurality of data elements;
validate indexed documentation associated with the one or more messages based on the one or more determined hierarchical paths; or
combinations thereof.

17. The non-transitory computer-readable medium of claim 16, wherein the dictionary data defines associations between the one or more data components and the plurality of data elements.

18. The non-transitory computer-readable medium of claim 17, wherein the dictionary data organizes the plurality of data elements and associated one or more data components as nodes within a hierarchical data structure.

19. The non-transitory computer-readable medium of claim 15, wherein validating each mapping rule comprises: utilizing a schema-compliant editing tool configured to automatically enforce compliance with the path schema.

20. The non-transitory computer-readable medium of claim 15, wherein determining hierarchical paths comprises performing XPath traversal algorithms on the modified dictionary data
